(19) United States
(12) Patent Application Publication
(10) Pub. No.: US 2026/0134456 A1
(43) Pub. Date: May 14, 2026

(54) SYSTEMS AND METHODS FOR DISTRIBUTING AI-BASED GENERATIVE RESPONSIVE CONTENT OVER NETWORKS

(71) Applicant: Intentful Incorporated, New York, NY (US)

(72) Inventors: Marina Petrova, Hopatcong, NJ (US); Bruce Elyea Amick, New York, NY (US); Oleksandr Shcherban, Kyiv (UA)

(21) Appl. No.: 19/389,887

(22) Filed: Nov. 14, 2025

Related U.S. Application Data
(60) Provisional application No. 63/720,417, filed on Nov. 14, 2024.

(51) Int. Cl. G06Q 30/0241

(52) U.S. Cl. CPC G06Q 30/0277

(57) ABSTRACT

Various embodiments of the present disclosure relate to providing AI-based generation of responsive content. In an example embodiment, generative response content is an AI-powered interactive interface embedded within presented content, allowing users to ask questions and receive relevant, real-time answers directly within the content space, without requiring a click or further interaction to access a landing page.

### CROSS REFERENCE TO RELATED APPLICATIONS

This application claims priority to U.S. Provisional Application No. 63/720,417, entitled “SYSTEM AND METHOD FOR AI-BASED GENERATION OF RESPONSIVE ADVERTISEMENTS”, filed Nov. 14, 2024, the entirety of which is incorporated by reference herein for all purposes.

### BACKGROUND

Various embodiments of the present disclosure address technical challenges related to data processing and computational efficiency in automated systems. In various computing environments, large volumes of data may be processed to generate actionable insights or predictions through algorithmic analysis. Traditional data processing systems are often limited by computational constraints, memory allocation inefficiencies, and processing bottlenecks that reduce overall system performance. The efficacy of automated data processing within a particular computing domain is constrained by a system's capability of efficiently handling data throughput while maintaining accuracy and reliability. This task is hindered by several technical challenges presented by systems that (i) experience scalability limitations under increased data loads, (ii) suffer from processing delays due to inefficient resource allocation, or (iii) demonstrate reduced accuracy when processing diverse data types simultaneously. Some existing content distribution systems, such as those configured for distributing static advertisements or videos, require distributing fixed content to end users. A need exists for systems enabling efficient ways of distributing content capable of interacting with consumers without requiring those consumers to navigate away from webpages they are currently viewing. Various embodiments of the present disclosure make important contributions to traditional data processing technologies by addressing these technical challenges, among others.

### BRIEF SUMMARY

Example embodiments of the present disclosure relate to providing AI-based generation of responsive content. In some examples, generative response content comprises AI-powered interactive advertisements allowing users to ask questions and receive relevant, real-time answers directly within the advertisement space, without requiring a click or further interaction to access a landing page. Such AI-based generation of responsive content may reshape how brands engage with users by delivering instant interactions directly within the content space, in real-time, providing a natural conversation experience and ensuring users can find the information they need in the moment. In some embodiments, such generative response content makes engagement with users more efficient and meaningful.

In some embodiments, generative response content of the present disclosure may allow brands to connect with their audiences in real time and deliver relevant information directly within the space of the generative response content. Example generative response content of the present disclosure may provide real-time, contextually relevant answers, helping users to engage directly with the brand. Such a format may be ideal for any industry where users seek quick, reliable answers that drive engagement and conversions. For example, by leveraging a tailored artificial intelligence-based solution that provides immediate responses within the space of the generative response content, various generative response content of the present disclosure may reduce friction and keep users engaged, driving stronger connections and potentially minimizing number of clicks to conversions.

In some embodiments, generative response content of the present disclosure may increase dwell time, enhance content value, and/or drive deeper user interactions for publishers struggling to find new revenue streams. For example, generative response content of the present disclosure may provide a scalable solution that boosts advertisement inventory value and/or keeps audiences within the publisher ecosystem longer.

In some embodiments, generative response content of the present disclosure may offer a future-forward advertisement format for agencies that boosts engagement and delivers real-time insights, including helping to optimize campaigns, ensure relevance, and/or showcase innovation to clients across a variety of industries. Training data may be updated selectively, such input provided by end users interacting with content does not automatically become part of the training data. Instead, end user input provided to an advertisement may be ephemeral, and may be deleted once the user interaction with an advertisement ends. In other embodiments, training data may be updated based on user input from select users only, and only after requesting that the user approve the use of their input as training data, so that their input may be used as a part of a feedback scheme for automatic, continuous, training of the machine learning pipeline for improved predictions (e.g., actionable insights that may help refine brand strategies and stay aligned with evolving customer needs). These select users may be users associated with the advertiser, focus groups, and/or the like. Other technical improvements and advantages may be realized by one of ordinary skill in the art.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings. Some embodiments may include the components arranged in a different way:

FIG. 1 illustrates an example computing system in accordance with various example embodiments of the present disclosure.

FIG. 2 is a schematic diagram showing a system computing architecture in accordance with various embodiments of the present disclosure.

FIG. 3 illustrates an example content distribution system that may be specially configured within which one or more embodiments of the present disclosure may operate.

FIG. 4 is a flowchart depicting operational steps of a process for generative response content distribution in accordance with some embodiments of the present invention.

FIG. 4B is a flowchart depicting operational steps of a process for generative response content distribution in accordance with some embodiments of the present invention.

FIGS. 5-15 illustrate example generative response content in accordance with various embodiments of the present disclosure.

### DETAILED DESCRIPTION

Various embodiments of the present disclosure provide optimized content that provides relevant, real-time answers that are renderable directly within the content space/window, without requiring a click or further interaction from the user to redirect a browser to access a landing page to interact with the content and to provide textual prompts into the content.

Generative response content (GRC) may be used within digital advertising ecosystems to create more engaging and informative user experiences. Advertisers deploy GRC through programmatic advertising platforms to reach target audiences with personalized, interactive content that can adapt to individual user queries and preferences. The functionality of GRC centers on the ability of GRC to provide real-time, contextually relevant responses while maintaining strict adherence to the advertiser's curated knowledge base, ensuring brand consistency and accuracy in all interactions.

In some embodiments, GRC may include user interactable interfaces embedded within presented content via which a user can interact with one or more large language model (LLM) enabled features, such as an agentic conversational interface configured to provide responses to one or more user queries. Programmatic advertising platforms distribute content through automated, real-time processes that may involve several interconnected systems and decision-making algorithms. The distribution process may begin when a user visits a website or opens an application that contains advertising inventory. The programmatic advertising platform may be configured to analyze available advertising space, collect contextual information about the (i) webpage content, (ii) user device characteristics, (iii) geographic location, and (iv) timing. A programmatic advertising platform may also access user profile data and behavioral patterns stored in data management platforms to understand audience characteristics and preferences.

The knowledge base may be stored using one or more distributed storage systems optimized for semantic search and retrieval. Source data may be processed through natural language processing pipelines that extract entities, relationships, and semantic meaning, creating structured metadata that enhances retrieval accuracy, and may be converted into vector representations. Upon receipt of a user query through a conversational interface, the system may process the input through intent recognition algorithms, convert the query into vector representations using the embedding models utilized with respect to the knowledge base, for example. The system may be configured to access third-party models when providing GRC using standardized integration protocols and communication interfaces that enable seamless interoperability between the GRC platform and external artificial intelligence or LLM services, for example. The system may utilize application program interfaces (APIs) or Model Context Protocol (MCP) to enable structured exchange of contextual information, conversation state, and operational parameters between the GRC platform and external models.

One or more embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard). It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements. Moreover, while certain embodiments of the present disclosure are described with reference to predictive or insight data analysis, one of ordinary skills in the art will recognize that the disclosed concepts may be used to perform other types of data analysis.

### I. Example Terminology

The techniques of the present disclosure are applicable to any type of machine learning model, algorithm, and/or the like. The inputs, outputs, categorizations, and/or labels may be based at least in part on the type, purpose, and/or architecture of the particular machine learning model.

The term "generative response content (GRC)" refers to interactive digital content that incorporates artificial intelligence-powered conversational elements (e.g., using a large language model (LLM) for generation of content) for end user engagement. Generative response content may comprise a sophisticated form of digital advertising that transcends traditional static content by providing dynamic, personalized interactions through AI-driven conversational interfaces. Generative response content may be specifically designed to engage end users in meaningful dialogue while delivering targeted information based on curated data provided by advertisers or brands.

Some embodiments of GRC may include implementations across various media formats, such as audio-only conversational interfaces for radio advertising, video-integrated chatbots for streaming platforms, or voice-activated interfaces for smart device ecosystems. Some embodiments may also incorporate multimodal capabilities, combining text, image, and audio responses to create richer interactive experiences, or may be adapted for specific industry verticals such as healthcare, finance, or e-commerce with specialized knowledge domains and compliance requirements. In some embodiments, GRC may comprise text-based interactions with end-users, provided on existing text-based communication platforms (e.g., “text messages” or “short message service (SMS)” messages, WeChat, WhatsApp, Facebook Messenger, or other direct-message platforms). As discussed herein, GRC (regardless of text-based, audio-based, video-based, or otherwise) is configured to convey particular information or content to an end user based, at least in part, on training data and context limiting the scope of information to be conveyed to end users. The GRC is also configured to be embedded within a container distributed to end users as a part of a response to a content request from the end user requesting other content, for example, on a webpage. In such embodiments, the GRC is provided as a part on a container designated within the webpage content. The training data may include data which is generated according to, or determined as complying with, one or more defined preferences and/or training data directed to the subject matter for which the GRC is intended to describe.

With respect to one example use case, generative response content may comprise an interactive digital advertisement that provides dynamic, AI-powered conversational experiences in place of traditional static advertisements. In such embodiments, GRC enables end users to engage directly with advertisements through natural language interactions, asking questions and receiving real-time, contextually relevant responses without leaving the advertisement space or being redirected to external pages. In such embodiments, the GRC may be provided based on large language models trained on curated brand-specific knowledge bases that contain product information, service details, pricing data, promotional offers, and other advertiser-provided content, thereby enabling conversational responses which remain aligned with an advertiser’s messaging strategy, brand voice, and factual accuracy requirements while preventing generation of inappropriate or off-brand content.

The term "digital impression" refers to a deliverable content unit designed for presentation to end users across various digital media channels. A GRC may be incorporated as a part of a digital impression. A digital impression represents a fundamental unit of digital advertising that encompasses elements configured to convey a marketing message or brand communication to a target audience. Digital impressions may be engineered to be platform-agnostic and can be seamlessly integrated into diverse digital environments, from web-based containers provided on webpages to temporal media slots in audiovisual content (e.g., “commercials” interspersed within content on a web-based video platform).

Digital impressions may be utilized within programmatic advertising ecosystems where digital impressions serve as the primary deliverable unit for brand communications. Digital impressions may comprise containers that house various content types, from static images and text to interactive elements and embedded conversational interfaces. Digital impressions may provide seamless integration with publisher platforms, real-time rendering across different device types and screen sizes, and comprehensive tracking of user engagement metrics.

Some embodiments of digital impressions may include adaptive formats that dynamically adjust content based on user device capabilities, contextual impressions that modify content based on surrounding editorial content, or immersive formats designed for augmented reality (AR) and virtual reality (VR) environments. Some digital impressions may also comprise progressive loading capabilities for bandwidth-constrained environments or incorporate blockchain-based verification systems for enhanced transparency and fraud prevention.

The term "GRC knowledge data" refers to a structured dataset comprising a foundational information source for AI-powered conversational elements within generative response content. In some embodiments, GRC knowledge data may be curated, by an end user or an authorized user, such that the data is filtered, preprocessed, or otherwise managed to ensure that the GRC knowledge data is consistent with client objectives or preferences. GRC knowledge data may comprise a repository of brand-specific information that defines the scope and boundaries of what an AI conversational interface can communicate to end users. GRC knowledge data may constrain the content that can be generated and provided to end users, ensuring that AI-generated responses remain aligned with the advertiser's messaging strategy, brand voice, and factual accuracy requirements.

GRC knowledge data may be used to train and constrain large language models, ensuring that conversational interfaces provide accurate, brand-consistent responses while avoiding hallucinations or off-topic discussions. GRC knowledge data may comprise a dynamic knowledge base that can be updated and refined based on new source content, performance metrics, and evolving business requirements. GRC knowledge data may provide an authoritative source for all conversational AI interactions, maintaining strict boundaries around what information can be shared and how information should be presented.

Some embodiments of GRC knowledge data may include multi-lingual knowledge bases for global brand campaigns, industry-specific knowledge repositories with specialized terminology and compliance requirements, or dynamic knowledge systems that automatically incorporate real-time data feeds such as pricing updates, inventory levels, or event information. GRC knowledge data may also comprise hierarchical access controls that provide different levels of information based on user authentication or conversation context.

The term "source data" refers to content assets provided and maintained by advertisers that serve as input for generating a GRC knowledge base and conversational AI training datasets. Source data may comprise raw, unprocessed information that originates directly from the advertiser's content ecosystem, including digital assets, documentation, and multimedia resources that contain the authoritative information about products, services, and brand messaging.

Source data is utilized as an input for knowledge base construction and AI model training processes. Source data functions as the authoritative reference point for all downstream content generation and conversational AI responses. The system processes raw content through transformation pipelines, including text extraction, image analysis, and structured data parsing, to create machine-readable formats suitable for AI training and inference.

Source data may include real-time data streams from e-commerce platforms, social media feeds, or customer relationship management (CRM) systems. Some implementations may incorporate multimedia source data processing capabilities for video and audio content, or may feature automated content validation systems that verify the accuracy and compliance of source materials. Source data may also include federated data sources that aggregate information from multiple advertiser systems while maintaining data privacy and security requirements.

The term "enrichment data" refers to manually curated metadata and annotations that enhance and contextualize source data to improve the performance and accuracy of AI-powered conversational interfaces. Enrichment data may comprise human-generated insights, labels, and contextual information that provide semantic meaning and structure to raw source content, enabling more sophisticated understanding and response generation by machine learning models.

Enrichment data may comprise additional context and semantic understanding that pure source data cannot convey, such as intent classification, emotional tone, priority levels, and relationship mappings between different content elements. The enrichment data may provide a bridge between human understanding and machine learning capabilities, translating implicit knowledge into explicit, machine-readable formats that improve AI response quality and relevance.

Some embodiments of enrichment data may include crowd-sourced annotations from multiple human reviewers, automated enrichment using pre-trained AI models for initial labeling, or domain-specific enrichment schemas tailored to particular industries or use cases. In some embodiments, the enrichment data may be provided via collaborative annotation platforms with consensus mechanisms or active learning systems that identify content requiring human annotation based on model uncertainty or performance gaps.

The term "impression content" refers to static and/or non-interactive visual and textual elements that form the contextual backdrop for conversational interfaces within digital advertisements. Impression content may comprise traditional advertising components that surround and complement the AI-powered conversational element, including brand imagery/video segments, color schemes, typography, layout design, and supporting marketing copy that collectively establish the visual identity and messaging framework for the interactive advertisement.

Impression content may establish brand recognition, convey key marketing messages, and create visual continuity with broader advertising campaigns while providing the contextual framework within which conversational interactions occur. The impression content may comprise a visual foundation that guides user attention and establishes expectations for the interactive experience, working in conjunction with conversational elements to create cohesive, branded user experiences.

Some embodiments of impression content may include dynamic visual elements that adapt based on conversation context, personalized imagery selected based on user demographics or behavior, or interactive visual components that respond to conversational triggers. In some embodiments, impression content may feature A/B testing capabilities for optimizing visual elements, or may incorporate accessibility features such as high-contrast modes, screen reader compatibility, and alternative text descriptions for inclusive user experiences.

The term "programmatic advertising platforms" refers to automated digital advertising ecosystems that facilitate the buying, selling, and delivery of advertising inventory through algorithmic processes and real-time decision-making systems. Programmatic advertising platforms may comprise infrastructures that connect advertisers, publishers, and intermediary services through automated auction mechanisms, enabling efficient and targeted advertisement placement across vast digital media networks.

Programmatic advertising platforms may be configured to automate the advertising supply chain, from inventory availability detection to final advertisement delivery and performance tracking. Programmatic advertising platforms may comprise intermediaries configured to match advertiser demand with publisher supply through sophisticated algorithms that consider factors such as user demographics, browsing behavior, contextual relevance, and bid prices. The programmatic advertising platforms may enable precise audience targeting, budget optimization, and campaign performance measurement across multiple channels and formats.

Some embodiments of programmatic advertising platforms include specialized platforms for emerging media formats such as connected TV, digital out-of-home advertising, or audio streaming services. In some embodiments, programmatic advertising platforms feature blockchain-based transparency mechanisms for enhanced fraud prevention, or may incorporate advanced privacy-preserving technologies such as differential privacy or federated learning to comply with evolving data protection regulations. Cross-platform attribution systems may also be integrated to provide comprehensive measurement across multiple touchpoints and devices.

The term "conversational interface" refers to an interactive communication system that enables natural language dialogue between end users and AI-powered systems through various input and output modalities. A conversational interface may comprise any user-facing component of AI-driven communication systems that can process, understand, and respond to human language in real-time, providing intuitive and accessible interaction mechanisms that mirror human-to-human conversation patterns.

Conversational interfaces may comprise intuitive, accessible interaction mechanisms for users to engage with AI-powered services, information systems, and automated assistants. Conversational interfaces may comprise a primary touchpoint between human users and complex AI systems, translating natural language inputs into structured queries and presenting AI-generated responses in human-readable formats. A conversational interface may be configured to maintain conversation context, manages dialogue flow, and provides appropriate responses based on user intent and available knowledge bases.

Some embodiments of conversational interfaces may include specialized implementations for accessibility, such as interfaces optimized for users with visual or hearing impairments, or domain-specific interfaces tailored for particular industries like healthcare or finance with specialized terminology and compliance requirements. In some embodiments, conversational interfaces incorporate multi-lingual capabilities with real-time translation, or may incorporate augmented reality (AR) overlays that combine conversational interactions with visual information display.

The term "large language model (LLM)" refers to a sophisticated artificial intelligence system based on transformer neural network architectures configured to understand, generate, and manipulate human language at scale. Large language models may comprise state-of-the-art natural language processing systems trained on vast corpora of text data, enabling large language models to perform a wide range of language-related tasks including text generation, question answering, summarization, and conversational dialogue with human-like fluency and contextual understanding.

LLMs may comprise a core intelligence engine for conversational interfaces, content generation systems, and various natural language processing applications. Large language models may be configured to process input text through neural network layers, generate probability distributions over possible next tokens or responses, and produce coherent, contextually appropriate outputs. In some embodiments, the LLMs can be fine-tuned on specific datasets or domains to improve performance for particular use cases while maintaining general language understanding capabilities.

Some embodiments of large language models may include specialized architectures optimized for specific domains such as code generation, scientific literature, or multilingual applications. In some embodiments, the LLMs comprise retrieval-augmented generation (RAG) capabilities that combine parametric knowledge with external knowledge bases, or may incorporate reinforcement learning from human feedback (RLHF) to align model outputs with human preferences. The LLMs may further include multi-modal capabilities that process and generate combinations of text, images, and other media types.

The term "distribution algorithm" refers to computational systems and methodologies that determine the optimal placement, timing, and targeting of digital content across various media channels and platforms. Distribution algorithms may comprise decision-making engines that process multiple variables including user characteristics, content context, inventory availability, and campaign objectives to make real-time determinations about content delivery and placement strategies.

Distribution algorithms are used within programmatic advertising ecosystems to automate the complex decision-making processes involved in content placement and audience targeting. Distribution algorithms may be configured to analyze vast amounts of real-time data including user behavior patterns, contextual signals, and historical performance metrics to make optimal placement decisions.

Some embodiments of distribution algorithms may include specialized implementations for emerging advertising formats such as connected TV, podcast advertising, or in-game advertising placements. In some embodiments, distribution algorithms may feature privacy-preserving algorithms that operate on encrypted or anonymized data, or may incorporate fairness constraints to ensure equitable content distribution across different demographic groups. The distribution algorithms may also include cross-platform optimization algorithms that coordinate content delivery across multiple channels and devices to maximize overall campaign effectiveness.

The term "interaction data" refers to comprehensive datasets that capture aspects of user engagement with conversational interfaces and digital content, including behavioral metadata, conversation transcripts, and contextual information about user sessions. Interaction data may comprise both explicit user inputs and implicit behavioral signals, providing detailed insights into user preferences, engagement patterns, and the effectiveness of AI-powered conversational systems.

Interaction data may enable performance analysis, model improvement, and user experience optimization across conversational AI systems and digital advertising platforms. The interaction data may provide a comprehensive feedback mechanism that enables continuous learning and adaptation of AI models, providing insights into user satisfaction, conversation effectiveness, and areas for system improvement.

Some embodiments of interaction data may include multi-modal interaction capture that records voice patterns, visual attention tracking, or gesture recognition data for more comprehensive user behavior analysis. In some embodiments, interaction data (or the systems configured to provide interaction data) utilizes federated learning approaches that enable model improvement without centralizing sensitive user data, or may incorporate blockchain-based systems for transparent and auditable interaction logging. In some embodiments, interaction data comprises predictive analytics data that anticipates user needs based on interaction patterns.

The term "conversation logs" refers to structured, chronological records that capture the complete dialogue exchange between end users and AI-powered conversational interfaces, including timestamps, user queries, system responses, and associated metadata. Conversation logs comprise detailed audit trails of conversational interactions that preserve the context, flow, and outcomes of each dialogue session, enabling comprehensive analysis of conversational AI performance and user engagement patterns.

Conversation logs may be used for performance monitoring, quality assurance, and continuous improvement of conversational AI systems. Conversation logs may provide a primary data source for analyzing conversation quality, identifying common user intents, detecting system failures or inappropriate responses, and measuring key performance indicators such as conversation completion rates and user satisfaction. The system enables detailed post-conversation analysis and provides insights for training data generation and model refinement.

Some embodiments of conversation logs include enhanced privacy-preserving implementations that store anonymized or encrypted conversation data, or may feature real-time analysis capabilities that provide immediate feedback on conversation quality and system performance. In some embodiments, the conversation logs may incorporate sentiment analysis and emotion detection to enrich log data with user experience insights, or may include integration with customer relationship management (CRM) systems for comprehensive user journey tracking. The conversation logs may comprise automated conversation summarization and key insight extraction to facilitate rapid analysis of large conversation datasets.

The term "end users" refers to the individual human participants who interact with digital content, conversational interfaces, and advertising systems as the ultimate consumers or recipients of information and services. End users represent the target audience for digital advertising campaigns and conversational AI systems, encompassing diverse individuals with varying demographics, preferences, technological capabilities, and interaction patterns who engage with digital platforms through various devices and channels.

End users may be the primary focus of digital advertising targeting, content personalization, and conversational AI optimization efforts. Understanding end user patterns enables optimization of content placement, content delivery, and conversational interface design to maximize engagement and satisfaction.

The term "log interface" refers to a user-facing dashboard or visualization system that provides accessible, interactive access to conversation logs and interaction data for analysis, monitoring, and system optimization purposes. A log interface may comprise a comprehensive data presentation layer that transforms raw conversation data into meaningful, actionable insights through various visualization techniques, filtering capabilities, and analytical tools designed for different user roles and use cases.

Log interfaces may enable administrators, data analysts, and system operators to monitor conversational AI performance, identify trends and patterns in user interactions, and make data-driven decisions about system improvements. The log interface comprises a comprehensive analytical tool that enables users to analyze specific conversations, aggregate data across multiple dimensions, and generate reports. The log interface may provide both real-time monitoring capabilities and historical analysis tools for comprehensive system oversight.

Some embodiments of log interfaces may include mobile-optimized versions for on-the-go monitoring, or may feature automated alerting systems that notify administrators of unusual patterns or system issues. In some embodiments, log interfaces incorporate natural language querying capabilities that allow users to ask questions about conversation data in plain English, or may include collaborative features that enable team-based analysis and annotation of conversation logs. Log interfaces may utilize predictive analytics dashboards that forecast future conversation trends and system performance based on historical data patterns.

The term "summary model" refers to an artificial intelligence system specifically designed to analyze and synthesize interaction logs and conversation data into concise, meaningful summaries that highlight key insights, patterns, and performance metrics. A summary model may comprise a specialized machine learning architecture that processes large volumes of conversational data to extract actionable intelligence, identify trends, and generate comprehensive reports that facilitate decision-making and system optimization.

Summary models may be configured to automatically generate comprehensive reports and insights from conversation logs, enabling stakeholders to quickly understand system performance, user satisfaction levels, and areas for improvement without manually reviewing individual conversations. The system functions by processing raw interaction data through multiple analytical lenses, generating both quantitative metrics and qualitative insights that inform strategic decisions about conversational AI optimization and user experience enhancement.

Summary models may include specialized implementations for different industries or use cases, such as healthcare conversation summarization with medical terminology understanding, or financial services summaries with compliance and regulatory focus. In some embodiments, summary models comprise multi-modal summarization capabilities that incorporate visual or audio interaction data, or may include real-time summarization systems that provide immediate insights as conversations occur. Summary models may comprise causal analysis capabilities that identify relationships between conversation characteristics and business outcomes, or may feature personalized summarization that adapts summary content based on the intended audience's role and information needs.

In some embodiments, the term "test queries" refers to systematically designed sets of input prompts and questions used to evaluate, validate, and optimize the performance of conversational AI interfaces through automated testing procedures. Test queries may comprise carefully curated collections of representative user inputs that span various conversation scenarios, edge cases, and use cases, enabling comprehensive assessment of conversational system capabilities, accuracy, and reliability.

Test queries may be used to ensure conversational AI systems meet quality standards, maintain consistent performance across updates, and identify areas requiring improvement or additional training. The test queries may provide a comprehensive quality assurance mechanism that enables systematic evaluation of conversational capabilities, helping developers and administrators understand system strengths and weaknesses. Test queries support both regression testing to ensure system stability and exploratory testing to discover new capabilities or limitations.

Some embodiments of test queries may include adaptive testing systems that automatically generate new test cases based on real user interactions and identified failure modes, or may feature specialized query sets for different domains such as customer service, technical support, or educational applications. Test queries may comprise multi-lingual test queries for global applications, or may include accessibility-focused queries that test system performance with users who have different interaction capabilities. In some embodiments, the test queries comprise adversarial testing capabilities that specifically probe for potential security vulnerabilities or inappropriate responses in conversational systems.

The term "validate" refers to a comprehensive evaluation process that systematically assesses the performance, accuracy, and reliability of conversational AI interfaces against predefined criteria and quality standards. Validation represents a multi-faceted quality assurance methodology that encompasses both automated testing procedures and human evaluation processes to ensure that conversational systems meet operational requirements, user expectations, and business objectives.

Validation processes are used to ensure conversational AI systems maintain high quality standards, provide accurate information, and deliver satisfactory user experiences before and after deployment. Validation enables iterative refinement of conversational AI capabilities and provides confidence in system reliability for business-critical applications.

Validation may include specialized validation procedures for regulated industries such as healthcare or finance, where accuracy and compliance requirements are particularly stringent. In some embodiments, validation comprises crowd-sourced validation techniques that leverage multiple human evaluators for comprehensive quality assessment, or may include domain-specific validation metrics tailored to particular use cases or industries. Validation may comprise longitudinal validation studies that assess system performance over extended periods, or may feature adaptive validation criteria that evolve based on changing user expectations and business requirements.

In some embodiments, the term "validation metric" refers to quantitative and qualitative measures used to assess the performance, effectiveness, and quality of conversational AI interfaces across various dimensions of user interaction and system capability. Validation metrics represent standardized measurement frameworks that enable objective evaluation of conversational systems, providing data-driven insights into system performance and areas for improvement.

Validation metrics are used to provide objective, measurable assessments of conversational AI performance that enable data-driven optimization decisions and quality assurance processes. The system functions as a comprehensive performance monitoring framework that tracks multiple aspects of conversational system effectiveness, from technical performance indicators like response time to user experience measures like satisfaction and engagement. Validation metrics support continuous improvement processes and provide stakeholders with clear visibility into system performance trends.

Some embodiments of validation metrics may include specialized metrics for different industries or applications, such as medical accuracy metrics for healthcare conversational systems or compliance metrics for financial services applications. Some implementations may feature composite metrics that combine multiple individual measures into overall quality scores, or may include predictive metrics that forecast future performance based on current trends. Advanced embodiments might also incorporate user-specific metrics that account for individual differences in interaction patterns and preferences, or may feature adaptive metrics that evolve based on changing business objectives and user expectations.

The term "validation user interface" refers to an interactive dashboard and control system that provides administrators and stakeholders with comprehensive access to validation metrics, testing results, and system optimization tools for conversational AI interfaces. A validation user interface may comprise a centralized management platform that combines data visualization, analytical tools, and system configuration capabilities to enable effective oversight and improvement of conversational AI performance.

Validation user interfaces may be used by administrators, data scientists, and business stakeholders to monitor conversational AI performance, configure testing procedures, and make informed decisions about system optimization and deployment. The interface functions as a comprehensive control center that provides both high-level performance overviews and detailed analytical capabilities, enabling users to drill down into specific performance issues and implement targeted improvements. The system supports both reactive problem-solving and proactive optimization strategies.

Some embodiments of validation user interfaces may include mobile-optimized versions for remote monitoring and management, or may feature voice-controlled interfaces for hands-free operation in certain environments. In some embodiments, validation user interfaces incorporate collaborative features that enable distributed teams to work together on system optimization, or may include automated recommendation systems that suggest optimization strategies based on performance data analysis. Validation user interfaces may integrate with external business intelligence tools, or may include customizable interface layouts that adapt to different user roles and preferences.

The term "administrator" refers to authorized personnel responsible for managing, configuring, and optimizing conversational AI systems and digital advertising platforms, including content management, system parameters, and performance monitoring. An administrator represents a privileged user role with comprehensive access to system configuration tools, data management capabilities, and optimization controls necessary for maintaining and improving conversational AI performance and advertising campaign effectiveness. Administrators ensure optimal performance, security, and compliance of conversational AI systems and advertising platforms through active management and continuous optimization. The administrator role functions as the primary human oversight mechanism for automated systems, providing strategic guidance, quality control, and technical expertise.

The term "business parameters" refers to configurable settings and characteristics that define the operational behavior, personality, and presentation style of conversational AI interfaces to align with specific brand identities, marketing objectives, and user experience requirements. Business parameters may comprise a comprehensive set of customizable attributes that enable advertisers and brands to tailor conversational interactions to match unique voice, messaging strategy, and target audience preferences.

Business parameters may enable customized conversational AI behavior to match brand identity and marketing objectives while maintaining consistency across all user interactions. In some embodiments, business parameters enable fine-tuned control over conversation tone, content focus, and user experience design.

Some embodiments of business parameters may include dynamic parameter adjustment based on user demographics or conversation context, or may feature machine learning systems that automatically optimize parameters based on user engagement and conversion metrics. In some embodiments, business parameters comprise industry-specific parameter templates for different business sectors, or may include collaborative parameter management tools that enable multiple stakeholders to contribute to parameter configuration. Business parameters may comprise predictive parameter optimization that anticipates optimal settings based on campaign objectives and historical performance data.

The term "Application Program Interface (API)" refers to a standardized set of protocols, tools, and specifications that enable different software systems and components to communicate, exchange data, and integrate functionality across the conversational AI and digital advertising ecosystem. APIs provides a technical foundation that enables seamless interoperability between large language models, conversational interfaces, programmatic advertising platforms, and various external systems and services.

The term "Model Context Protocol (MCP)" refers to a structured specification and communication framework that defines how contextual information, parameters, and data are exchanged between large language models and external systems or modules within the conversational AI and digital advertising ecosystem. MCP represents a standardized protocol that ensures consistent and efficient transfer of context, state information, and operational parameters between AI models and various system components such as programmatic advertising platforms, conversational interfaces, and content management systems. MCP is used to maintain consistent context and state information across distributed AI systems, enabling seamless coordination between large language models and external components while preserving conversation history, user preferences, and system state. MCP provides a standardized communication layer that ensures all system components have access to relevant contextual information necessary for optimal performance and user experience.

The term "metadata" refers to structured descriptive information that characterizes and provides context about target end users, content objects, system interactions, and operational parameters within the conversational AI and digital advertising ecosystem. Metadata may comprise comprehensive data attributes that enable precise targeting, personalization, and optimization of conversational experiences by providing detailed information about user characteristics, content properties, and system performance metrics.

Metadata is used to enable precise targeting, personalization, and optimization of conversational AI interactions by providing detailed context about users, content, and system state. The metadata may provide a comprehensive information layer that enhances decision-making capabilities across all system components, from content selection and user targeting to performance monitoring and system optimization. Metadata enables sophisticated analytics and reporting capabilities that drive continuous improvement of conversational AI performance.

Some embodiments of metadata may include privacy-preserving metadata implementations that use differential privacy or federated learning techniques to protect sensitive user information, or may feature dynamic metadata systems that automatically adapt metadata schemas based on evolving business requirements. In some embodiments, metadata comprises predictive metadata generation that anticipates future metadata needs based on system usage patterns and business objectives.

The term "target end users" refers to specific individuals or user segments that have been identified and selected as the intended recipients of particular impression content, conversational experiences, or advertising campaigns based on demographic, behavioral, contextual, or preference-based criteria. Target end users represent carefully defined audience segments that align with advertiser objectives and campaign goals, enabling precise delivery of relevant content and personalized conversational interactions. Target end users are used to optimize content delivery, personalization strategies, and campaign effectiveness by ensuring that conversational AI interactions and advertising content reach the most relevant and receptive audiences.

The term "end user profiles" refers to comprehensive digital representations of individual users that aggregate demographic information, behavioral patterns, preferences, and interaction history to enable personalized content delivery and targeted conversational experiences. End user profiles represent detailed user models that can be customized with different content sets, enrichment data, and targeting parameters to create highly specific audience segments ranging from broad demographic categories to granular behavioral micro-segments.

In some embodiments, end user profiles utilize multi-dimensional data structures implemented through graph databases or document stores that can efficiently represent complex user attributes and relationships. Advanced profiling systems incorporate privacy-preserving techniques such as differential privacy and federated learning to maintain user anonymity while enabling precise targeting. End user profiles may utilize profile synchronization mechanisms that maintain consistency across multiple touchpoints and devices, using probabilistic matching algorithms and deterministic linking for cross-device identity resolution. End user profiles are used to deliver highly personalized conversational experiences and targeted advertising content that aligns with individual user preferences, needs, and characteristics. In some embodiments, end user profiles support sophisticated targeting strategies that can range from broad demographic targeting to highly specific behavioral micro-targeting based on detailed user journey analysis. Some embodiments of end user profiles may include temporal profiles that capture user behavior changes over time, contextual profiles that adapt based on immediate situational factors, or privacy-first profiles that enable personalization without storing personally identifiable information.

The term "end user definitions" refers to structured specifications and criteria that define the characteristics, attributes, and parameters used to identify and categorize target audiences for end user profiles within the conversational AI and digital advertising ecosystem. End user definitions comprise the foundational targeting logic that determines which users should receive specific content, conversational experiences, or advertising campaigns based on predefined business rules and audience segmentation strategies.

End user definitions are used to establish clear, measurable criteria for audience targeting and segmentation, enabling consistent and scalable user classification across multiple campaigns and touchpoints. In some embodiments, end user definitions provide a targeting specification layer that translates business objectives into technical targeting parameters, ensuring that conversational AI interactions and advertising content reach precisely defined audience segments. End user definitions enable campaign managers and advertisers to create sophisticated targeting strategies without requiring deep technical knowledge of underlying data structures.

The term "alternative impression content" refers to backup or fallback content that can be delivered to end users when the primary conversational interface or AI-powered interactive elements cannot be properly rendered or executed due to technical limitations, system failures, or compatibility issues. Alternative impression content represents a contingency mechanism that ensures continuous advertising delivery and user experience even when advanced conversational AI features are unavailable. Alternative impression content may be used to maintain advertising campaign continuity and user experience quality when primary conversational AI systems are unavailable or incompatible with user environments. In some embodiments, alternative impression content enables robust advertising campaigns that can adapt to varying technical constraints while maintaining core messaging effectiveness.

The term "status changes" refers to real-time indicators and notifications that communicate the operational state, availability, and performance characteristics of large language models and other critical system components within the conversational AI and digital advertising ecosystem. Status changes represent dynamic system health information that enables proactive system management, automatic failover procedures, and informed decision-making about content delivery strategies.

Embodiments of status changes leverage sophisticated monitoring and alerting systems built on distributed observability platforms and real-time communication architectures. Status change systems utilize health check protocols, performance monitoring agents, and synthetic transaction testing to continuously assess system availability and performance across multiple metrics including response time, error rates, and throughput capacity. Systems configured for status change monitoring may comprise dashboards and alerting mechanisms that provide both real-time status visibility and historical trend analysis.

The term "Urchin Tracking Module (UTM) parameter" refers to standardized query string components appended to URLs that enable comprehensive tracking and attribution of web traffic sources, campaign effectiveness, and user journey analytics within the conversational AI and digital advertising ecosystem. UTM parameters represent a fundamental web analytics mechanism that provides detailed insights into how users discover and interact with conversational content and advertising campaigns across multiple channels and touchpoints.

The terms “trained machine learning model,” “machine learning model,” “machine-learning model,” “machine-learned component”, “model,” “one or more models,” “artificial intelligence”, “artificial intelligence component”, “AI” and/or the like may refer to a machine learning or deep learning task or mechanism. Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. For example, a machine learning model may be configured, trained (e.g., jointly, separately, etc.), and/or the like to perform an identification, classification, prediction, recommendation, and/or any other computing task, such as a data entity that describes parameters, hyper-parameters, and/or defined operations of a rules-based and/or machine learning model (e.g., model including at least one of one or more rule-based layers, one or more layers that depend on trained parameters, coefficients, and/or the like). In some embodiments, the machine learning model is a clustering model, a regression model, a neural network, a random forest, a decision tree model, a classification model, or the like.

A machine learning model may be initially fit or trained on a training dataset (e.g., a set of examples used to fit the parameters of the model). The machine learning model(s) may include one or more of any type of machine learning models including one or more supervised, unsupervised, semi-supervised, reinforcement learning models, and/or the like. For example, the model may be trained on the training dataset using supervised or unsupervised learning. The model is run with the training dataset and produces a result, which is then compared with a target, for input vectors in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network). The validation dataset includes input data that resembles typical input for the model (e.g., formatted in the same way and including the same types of data), but also includes model output data so that the output of the model based on the input may be compared against the model output data of the validation data set to ensure the model is producing proper output. In some embodiments, a machine learning model can be trained in real-time (e.g., online training) while in use. Moreover, a machine learning model may be refined over time.

Machine learning models, as described above, may make use of multiple ML engines, e.g., for analysis, recommendation generating, transformation, and other needs.

The system may train different machine learning models for different needs and different ML-based engines. The system may generate new models (e.g., based on the gathered training data) and may evaluate their performance against the existing models. Training data may include any of the gathered information, as well as information on actions performed based on the various recommendations.

Machine learning models may be any suitable model for the task or activity implemented by an ML-based engine. In some embodiments, a machine learning model is a clustering model, a regression model, a neural network, a random forest, a decision tree model, a classification model, or the like. Machine learning models are known in the art and are typically some form of neural network. The term refers to the ability of systems to recognize patterns on the basis of existing algorithms and data sets to provide solution concepts. The larger the training data set, the greater knowledge they develop.

The underlying machine learning models may be learning models (supervised or unsupervised). As examples, such algorithms may be prediction (e.g., linear regression) algorithms, classification (e.g., decision trees, k‐nearest neighbors) algorithms, time‐series forecasting (e.g., regression‐based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders, transformer-based), models combining planning with other models (e.g., PDDL-based), or Generative models (e.g., GANs, diffusion-based models).

Additionally or alternatively, machine learning models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other machine learning models may be generative models (such as Generative Adversarial Networks, diffusion-based or auto-encoders) to generate definitions and elements.

In various embodiments, machine learning models of the present disclosure may undergo a training or learning phase before they are released into a production or runtime phase or may begin operation with models from existing systems or models. During a training or learning phase, the machine learning models may be tuned (e.g., fine-tuned) to focus on specific variables, to reduce error margins, or to otherwise optimize their performance. The ML models may initially receive input from a wide variety of data.

In various embodiments and when appropriate for the particular task, one or more of the machine learning models of the present disclosure may be implemented with rule-based systems, such as an expert system or a hybrid intelligent system that incorporates multiple AI techniques.

A rule-based system is used to store and manipulate knowledge to interpret information in a useful way. It is often used in artificial intelligence applications and research. Rule-based systems constructed using automatic rule inference, such as rule-based machine learning, may be included in this system type. An example rule-based system is a domain-specific expert system that uses rules to make deductions or choices. For example, an expert system might help a doctor choose the correct diagnosis based on a cluster of symptoms or help a video game player to select tactical moves to play a game. Rule-based systems can be used to perform lexical analysis to compile or interpret computer programs, or in natural language processing. Rule-based programming attempts to derive execution instructions from a starting set of data and rules.

A hybrid intelligent system employs, in parallel, a combination of methods and techniques from artificial intelligence subfields, such as: Neuro-symbolic systems; Neuro-fuzzy systems; Hybrid connectionist-symbolic models; Fuzzy expert systems; Connectionist expert systems; Evolutionary neural networks; Genetic fuzzy systems; Rough fuzzy hybridization; and/or Reinforcement learning with fuzzy, neural, or evolutionary methods as well as symbolic reasoning methods. An example hybrid is a hierarchical control system in which the lowest, reactive layers are sub-symbolic. The higher layers, having relaxed time constraints, are capable of reasoning from an abstract world model and performing planning. Intelligent systems usually rely on hybrid reasoning processes, which include induction, deduction, abduction, and reasoning by analogy.

Further, a machine learning model or species thereof (e.g., “a large language model”, “a neural network”) of the present disclosure may comprise a single machine learning model or multiple machine learning models, such as a pipeline comprising two or more machine learning models arranged in series and/or parallel, an agentic framework of machine learning models, or the like.

The term “prompt engineering” refers to the practice of designing inputs for artificial intelligence (AI) tools that will cause the AI tools to produce desired results. Optimizing prompts for AI tools enables the efficient use of AI tools (e.g., LLMs or generative AI technologies) for a wide variety of use cases. With prompt engineering, text can be structured so that it can be interpreted and understood by a generative AI model. It will be appreciated that if any of the trained machine learning models described herein are implemented using LLMs or generative AI technologies, inputs to the various trained machine learning models may involve one or more prompts that are generated based on the inputs as described herein and are configured to obtain a desired result from the LLM or generative AI technology in as few prompts or turns as possible.

As used herein, the terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

Terms such as “computing,” “determining,” “generating,” and/or similar words are used herein interchangeably to refer to the creation, modification, or identification of data.

The term “component” or “application component” refers to a computer functionality or a set of computer functionalities, such as the retrieval of specified information or the execution of a set of operations, with a purpose that different clients may reuse for their respective purposes, together with the policies that should control its usage, for example, based on the identity of the client (e.g., an application, another component, etc.) requesting the component. Additionally, a component may support, or be supported by, at least one other component via a component dependency relationship. For example, a translation application stored on a smartphone may call a translation dictionary component at a server in order to translate a particular word or phrase between two languages. In such an example the translation application is dependent on the translation dictionary component to perform the translation task.

In some embodiments, a component is offered by one computing device over a network to one or more other computing devices. Additionally, the component may be stored, offered, and utilized by a single computing device to local applications stored thereon and in such embodiments a network would not be required. In some embodiments, components may be accessed by other components via a plurality of APIs, for example, JavaScript Object Notation (JSON), Extensible Markup Language (XML), Simple Object Access Protocol (SOAP), Hypertext Markup Language (HTML), the like, or combinations thereof. In some embodiments, components may be configured to capture or utilize database information and asynchronous communications via message queues (e.g., Event Bus). Non-limiting examples of components include an open-source API definition format, an internal developer tool, web-based HTTP components, database components, and asynchronous message queues which facilitate component-to-component communications.

In some embodiments, a component may represent an operation with a specified outcome and may further be a self-contained computer program. In some embodiments, a component from the perspective of the client (e.g., another component, application, etc.) may be a black box (e.g., meaning that the client need not be aware of the component’s inner workings). In some embodiments, a component may be associated with a type of feature, an executable code, two or more interconnected components, and/or another type of component associated with an application framework.

In some embodiments, a component may correspond to a service (e.g., a web service). Additionally or alternatively, in some embodiments, a component may correspond to a library (e.g., a library of components, a library of services, etc.). Additionally or alternatively, in some embodiments, a component may correspond to one or more modules. Additionally or alternatively, in some embodiments, a component may correspond to one or more machine learning models. For example, in some embodiments, a component may correspond to a service associated with a type of service, a service associated with a type of library, a service associated with a type of feature, a service associated with an executable code, two or more interconnected services, and/or another type of service associated with an application framework.

The terms “application,” “software application,” “app,” “product,” “service” or similar terms refer to a computer program or group of computer programs designed to perform coordinated functions, tasks, or activities for the benefit of a user or group of users. A software application may run on a server or group of servers (e.g., physical or virtual servers in a cloud-based computing environment). In certain embodiments, an application is designed for use by and interaction with one or more local, networked or remote computing devices, such as, but not limited to, client devices. Non-limiting examples of an application comprise website editing services, document editing services, word processors, spreadsheet applications, accounting applications, web browsers, email clients, media players, file viewers, collaborative document management services, videogames, audio-video conferencing, and photo/video editors.

In some embodiments, an application is a cloud product. When associated with a client device, such as a mobile device, communication with hardware and software modules executing outside of the application is typically provided via application programming interfaces (APIs) provided by the mobile device operating system.

The phrases “in one embodiment,” “according to one embodiment,” “in some embodiments,” and the like generally mean that the particular feature, structure, or characteristic following the phrase may be included in the at least one embodiment of the present disclosure and may be included in more than one embodiment of the present disclosure. Thus, the particular feature, structure, or characteristic may be included in more than one embodiment of the present disclosure such that these phrases do not necessarily refer to the same embodiment. Further, “based on,” “based at least in part on,” “based at least on,” “based upon,” and/or similar words are used herein interchangeably in an open-ended manner such that they do not indicate being based only on or based solely on the referenced element or elements unless so indicated.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such a component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations.

The term “set” refers to a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

The term “or” is used herein in both the alternative and conjunctive sense, unless otherwise indicated.

### II. Computer Program Products Methods and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read-only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random-access memory (CBRAM), phase-change random-access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations. As used herein, the description may refer to a server or client device as an example “apparatus.” However, elements of the apparatus described herein may be equally applicable to the claimed system, method, and computer program product. Accordingly, use of any such terms should not be taken to limit the spirit and scope of embodiments of the present disclosure.

Embodiments of the present disclosure are described below with reference to block diagrams. Thus, it should be understood that each block of the block diagrams may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### III. Example Framework

Having set forth a series of definitions called-upon throughout this application, an example system architecture and example apparatus are described below for implementing example embodiments and features of the present disclosure.

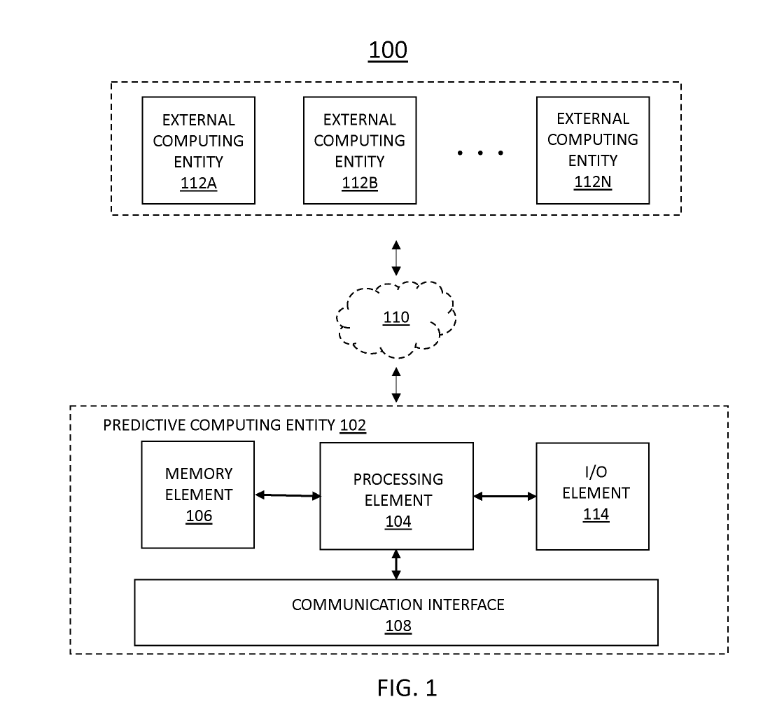

FIG. 1 illustrates an example computing system 100 that may be specially configured within which one or more embodiments of the present disclosure may operate. As shown in FIG. 1, the computing system 100 (e.g., a predictive computing system) may include a predictive computing entity 102 and/or one or more external computing entities 112A-N communicatively coupled to the predictive computing entity 102 using one or more wired and/or wireless communication techniques, such as wireless or wired network 110. The network(s) 110 may include, but are not limited to, any one or a combination of different types of suitable communications networks such as cable networks, public networks (e.g., the Internet), private networks (e.g., frame-relay networks), wireless networks, cellular networks, telephone networks (e.g., a public switched telephone network), or any other suitable private and/or public networks. Further, the network(s) 110 may have any suitable communication range associated therewith and may include, for example, global networks (e.g., the Internet), a wired or wireless Personal Area Network (PAN), Local Area Network (LAN), Metropolitan Area Network (MAN), Wide Area Network (WAN), and/or the like. In addition, the network(s) 110 may include any type of medium over which network traffic may be carried including coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing systems provided by network providers or other entities. The example computing system 100 may be embodied as a backend component of a GRC distribution system, configured to analyze and manage knowledge associated with a client, for example.

The predictive computing entity 102 may include one or more devices and/or sub-systems that may be specially configured to perform one or more steps/operations of one or more techniques or processes as described herein. In general, the terms “computing device,” “entity,” “device,” “system,” and/or similar words used herein interchangeably may refer to, for example, one or more computers, computing devices, computing entities, desktop computers, mobile phones, tablets, phablets, notebooks, laptops, distributed systems, terminals, servers or server networks, blades, gateways, switches, processing devices, set-top boxes, relays, routers, network access points, base stations, the like, and/or any combination of devices adapted to perform the functions, operations, and/or processes described herein. Such functions, operations, and/or processes may include, for example, transmitting, receiving, operating on, processing, displaying, storing, determining, generating/creating, monitoring, evaluating, comparing, and/or similar terms used herein interchangeably. In one embodiment, these functions, operations, and/or processes may be performed on data, content, information, and/or similar terms used herein interchangeably. For example, in some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112A-N to perform one or more steps/operations of one or more techniques (e.g., AI-based techniques for generation of responsive content, and/or the like) described herein.

The external computing entities 112A-N, for example, may include and/or be associated with one or more data source entities, user computing entities, and/or the like. The external computing entities 112A-N may be configured to receive, store, manage, and/or facilitate one or more datasets that may be accessible to the predictive computing entity 102. The external computing entities 112A-N, for example, may provide data to the predictive computing entity 102 which may be leveraged to generate responsive content and/or train or fine-tune one or more machine learning models. The external computing entities 112A-N, for example, may be associated with one or more data repositories, cloud platforms, computer nodes, organizations, and/or the like, that may be individually and/or collectively leveraged by the predictive computing entity 102 to obtain and aggregate data regarding AI- generation of responsive content, and the like.

In addition, or alternatively, the external computing entities 112A-N may include one or more user devices, such as one or more laptops, mobile devices, desktop computers, and/or the like. The external computing entities 112A-N, for example, may be individually and/or collectively leveraged by the predictive computing entity 102 to present information to a user and/or receive user input.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways to provide AI-generated responsive content and/or the like. The predictive computing entity 102 may be configured for a particular use or configured to execute instructions stored in volatile or non-volatile media or otherwise accessible to the processing element 104 to provide AI-generated responsive content and/or the like. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112A-N, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces or user interface components for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces or user interface components from a user of the computing system 100 and provide data to a user through the user interfaces or user interface components.

While FIG. 1 illustrates certain system devices as separate, standalone devices, the various embodiments are not limited to this particular architecture.

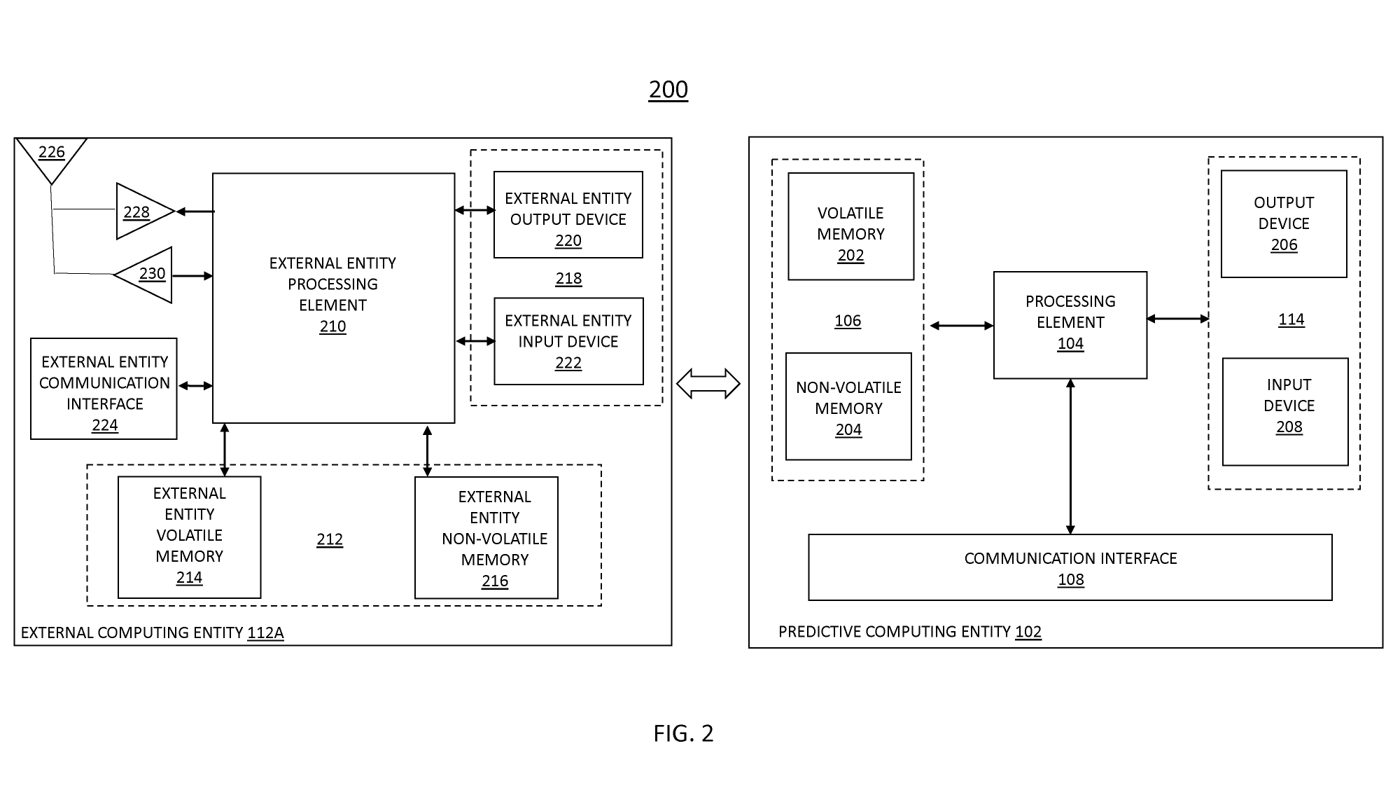

FIG. 2 is a schematic diagram showing a system computing architecture 200 in accordance with some embodiments discussed herein. In some embodiments, the system computing architecture 200 may include the predictive computing entity 102 and/or the external computing entity 112A of the computing system 100. The predictive computing entity 102 and/or the external computing entity 112A may include a computing apparatus, a computing device, and/or any form of computing entity configured to execute instructions stored on a computer-readable storage medium to perform certain steps or operations. The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read-only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more steps/operations described herein.

The predictive computing entity 102 may be embodied by a computer program product including non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a network or communication interface 108, with one or more external computing entities such as the external computing entity 112A. The communication interface 108 may be compatible with one or more wired and/or wireless communication protocols. For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The predictive computing entity 102 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the predictive computing entity components may be located remotely from other predictive computing entity 102 components, such as in a distributed system. Furthermore, one or more of the components may be aggregated and additional components performing functions described herein may be included in the predictive computing entity 102.

Turning to the external computing entity 112A of FIG. 2, the external computing entity 112A may include an external entity processing element 210, an external entity memory element 212, an external entity communication interface 224, and/or one or more external entity I/O elements 218 that communicate within the external computing entity 112A via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216, which may be embedded and/or may be removable. The external entity communication interface 224 may include one or more wired and/or wireless communication interfaces as described with reference to communication interface 108. In some embodiments, the external entity communication interface 224 may be supported by one or more radio circuitry. For instance, the external computing entity 112A may include an antenna 226, a transmitter 228 (e.g., radio), and/or a receiver 230 (e.g., radio), with the external entity processing element 210 providing signals to and receiving signals from the transmitter 228 and receiver 230, respectively.

Signals provided to and received from the transmitter 228 and the receiver 230, correspondingly, may include signaling information/data in accordance with air interface standards of applicable wireless systems to communicate with various devices, such as a predictive computing entity 102, another external computing entity 112N, and/or the like. In this regard, the external computing entity 112A may be capable of operating with one or more air interface standards, communication protocols, modulation types, and access types. More particularly, the external computing entity 112A may operate in accordance with any of a number of wireless communication standards and protocols, such as those described above with regard to the predictive computing entity 102. In an example embodiment, the transmitter 228 and/or receiver 230 are configured to communicate via one or more SRC protocols. For example, the transmitter 228 and/or receiver 230 may be configured to transmit and/or receive information/data, transmissions, and/or the like of at least one of Bluetooth protocols, low energy Bluetooth protocols, NFC protocols, RFID protocols, IR protocols, Wi-Fi protocols, ZigBee protocols, ZWave protocols, 6LoWPAN protocols, and/or other short range communication protocol. In various embodiments, the antenna 226, transmitter 228, and receiver 230 may be configured to communicate via one or more long range protocols, such as GPRS, UMTS, CDMA200, 1xRTT, WCDMA, GSM, EDGE, TD-SCDMA, LTE, E-UTRAN, EVDO, HSPA, HSDPA, Wi-Fi, Wi-Fi Direct, WiMAX, and/or the like.

In this regard, the external computing entity 112A may be capable of operating with one or more air interface standards, communication protocols, modulation types, and access types. More particularly, the external computing entity 112A may operate in accordance with any of a number of wireless communication standards and protocols. In a particular embodiment, the external computing entity 112A may operate in accordance with multiple wireless communication standards and protocols, such as GPRS, UMTS, CDMA200, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the external computing entity 112A may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112A may also download changes, add-ons, and updates, for instance, to its firmware, software (e.g., including executable instructions, applications, program modules), operating system, and/or the like.

According to one embodiment, the external computing entity 112A may include location determining embodiments, devices, modules, functionalities, and/or the like. For example, the external computing entity 112A may include outdoor positioning embodiments, such as a location module adapted to acquire, for example, location data including latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112A in connection with a variety of other systems, including cellular towers, Wi-Fi access points, and/or the like. Similarly, the external computing entity 112A may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, mouse, microphone, and/or the like) that may be coupled to the external entity processing element 210. For example, the user interface may be configured to provide an application (e.g., mobile app), browser, interactive user interface, dashboard, webpage, and/or similar words used herein interchangeably executing on and/or accessible via the external computing entity 112A to cause display or audible presentation of information/data and for user interaction therewith via one or more user input interfaces. In one embodiment, the functionality described herein (and user interface) may be provided as a standalone app executing on the external computing entity 112A. In such an implementation, the standalone app may be integrated with a variety of other apps executing on the external computing entity 112A to provide authentication functionality for other apps. For example, the user interface may be a user application, browser, and/or similar words used herein interchangeably executing on and/or accessible via the external computing entity 112A to interact with and/or cause the display, announcement, and/or the like of information/data to a user.

The user input interface may include any of a number of input devices or interfaces allowing the external computing entity 112A to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112A and may include a full set of alphabetic keys or set of keys that may be activated to provide a full set of alphanumeric keys. Through such inputs, the external computing entity 112A may capture, collect, store information/data, user interaction/input, and/or the like. In addition to providing input, the user input interface may be used, for example, to activate or deactivate certain functions, such as screen savers, sleep modes, and/or the like.

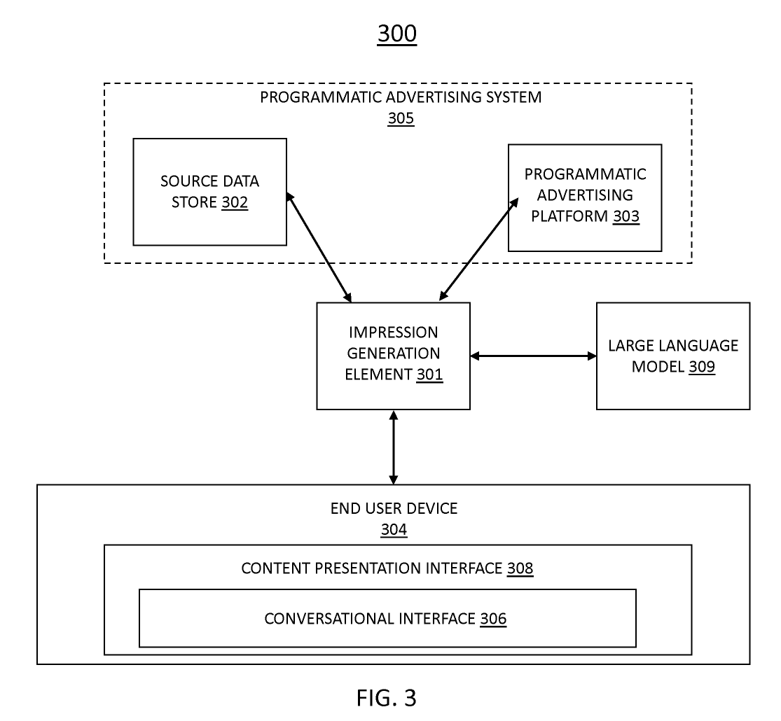

FIG. 3 illustrates an example content distribution system 300 that may be specially configured within which one or more embodiments of the present disclosure may operate. As depicted, the content distribution system 300 may include an impression generation element 301, a source data store 302, a programmatic advertising platform 303, and an end user device 304. As depicted, the source data store 302 and the programmatic advertising platform 303 may be embodied as separate components, or may be co-hosted by/integrated into a programmatic advertising system 305. The impression generation element 301 may be configured to execute any number of the processes or operations described herein. The content distribution system 300 may correspond to a frontend component of a GRC distribution platform, enabling operations associated with distribution of digital impressions and GRC.

In some embodiments, the impression generation element 301 may be configured to provide operations via which conversational behavior, response logic, tone, and style, as generated and presented to the user via the conversational interface 306, for example, can be altered, tailored, or otherwise managed. In some embodiments, the conversational design operations may be configured to enable branding controls, including (but not limited to) management of fonts, visual styles, and other design parameters to ensure brand fidelity. The impression generation element 301 may be configured to ensure consistency with respect to generative response content by applying user/client preferences to generative response content. In some embodiments, the impression generation element 301 provides a set of parameters to the large language model 309 such that the large language model 309 generates response content which aligns with the user/client preferences. For example, if the user/client preferences indicate a preferred tone of response with respect to user queries, the impression generation element 301 may be configured to provide the large language model 309 with one or more parameters or other indicators of the preferred tone. Subsequently, the large language model 309 may be configured to generate a reply to the user queries that is consistent with the preferred tone. In some embodiments, the impression generation element 301 may be configured to apply the user/client preferences to one or more responses generated by the large language model 309. For example, the large language model 309 may be configured to generate response data responsive to a user query as provided by the impression generation element 301. The impression generation element 301 may be configured to verify and/or apply user preferences to the generated response data. For example, the impression generation element 301 may use natural language processing techniques to determine whether the generated response data adheres to the user preferences regarding tone. In some embodiments, the impression generation element 301 is configured to update the generated response data to better reflect the user preferences.

The impression generation element 301 may be configured to apply user preferences to the generated response data. For example, if the user preferences indicate a preferred font or style, the impression generation element 301 may be configured to (i) receive response data from the large language model 309, and (ii) generate updated response data in a font or style as indicated by the user preferences. Managing font, style, and other display preferences via the impression generation element 301 rather than the large language model 309 may enable updates to display settings without requiring reinitiation of the large language model 309, for example.

In at least some embodiments, the impression generation element 301 may be configured comprising a knowledge engine. The knowledge engine may include one or more interfaces via which an authorized user can access, view, and interact with client-specific data or knowledge bases constructed from documents, URLs, and other provided data. In some embodiments, the knowledge engine provides an interface via which an authorized user can access various data elements of the source data store 302 and/or the programmatic advertising platform 303. Such an interface may enable a user to view, select, exclude, filter, and/or annotate various client-specific data, thereby enabling the authorized user to curate the client-specific data such that only data which reflects or indicates desired features is utilized with respect to the knowledge engine. For example, the knowledge engine may provide an interface via which the user can view a set of previous advertisements associated with a client, such that the large language model and/or the impression generation element 301 can process the set of previous advertisements to determine a preferred tone utilized with respect to the advertisements. In such an example, the authorized user may select a subset of the set of previous advertisements for exclusion from the knowledge engine. The subset of the set of previous advertisements may comprise, for example, advertisements which were associated with unsuccessful products or campaigns, and therefore may include features which are not desirable for inclusion in future generated content.

The source data store 302 may include robust content management systems implemented on scalable cloud infrastructure with automated ingestion pipelines. The source data store 302 may utilize web scraping technologies, API integrations, and file processing algorithms to collect and normalize data from diverse sources. The source data store 302 may employ distributed storage solutions, potentially leveraging object storage systems with metadata cataloging systems built on relational databases. In some embodiments, the source data store 302 may utilize advanced change detection algorithms to monitor source content for updates, utilizing checksums, timestamps, and content hashing to identify modifications. The source data store 302 may utilize both automated and manual update mechanisms, allowing for real-time synchronization or controlled, scheduled updates based on business requirements.

In some embodiments, the source data store 302 and/or the programmatic advertising platform 303 may be configured to enable operations for management of a knowledge base. Such operations may include executable commands enabling uploading, editing, and curating source materials such as documents, URLs, and structured data. In some embodiments, the knowledge base management operations enable tools for knowledge processing, including tools which enable ingestion, enrichment, and faceting of uploaded content to prepare data for retrieval.

The source data store 302 and/or the programmatic advertising platform 303 may comprise one or more annotation management systems built on collaborative platforms with version control and workflow management capabilities. Such annotation management systems utilize tagging interfaces, often implemented as web-based applications with rich text editors and multimedia annotation tools, allowing human annotators to add labels, categories, and contextual information to source content. The source data store 302 and/or the programmatic advertising platform 303 may be configured to employ graph databases or document stores optimized for hierarchical and relational metadata storage. In some embodiments, the source data store 302 and/or the programmatic advertising platform 303 may utilize machine learning pipelines to process enriched data using natural language processing techniques, including named entity recognition, sentiment analysis, and topic modeling, to create enhanced training datasets for conversational AI models.

In some embodiments, the programmatic advertising platform 303 may be configured to provide impression content. The programmatic advertising platform 303 may comprise content management and rendering systems built on responsive web design frameworks and dynamic content assembly platforms. Such content management and rendering systems utilize CSS preprocessing technologies, JavaScript frameworks, and HTML5 standards to create adaptive layouts that function across diverse device types and screen resolutions. In some embodiments, the programmatic advertising platform 303 employs (i) content delivery networks (CDNs) with edge caching capabilities to ensure rapid loading of visual assets, and/or (ii) image optimization algorithms to automatically compress and format media files for optimal performance. Advanced templating engines allow for dynamic assembly of impression content based on targeting parameters, user device capabilities, and real-time bidding contexts.

In some embodiments, the programmatic advertising platform 303 comprises distributed computing systems built on high-performance, low-latency infrastructure capable of processing millions of bid requests per second. The programmatic advertising platform 303 may be configured to utilize real-time bidding (RTB) protocols implemented through RESTful APIs and specialized communication protocols that enable millisecond-level auction processes. The programmatic advertising platform 303 may employ machine learning algorithms, including gradient boosting models, neural networks, and ensemble methods, for bid optimization, audience targeting, and performance prediction. Data management platforms (DMPs) integrated within programmatic advertising platforms utilize both relational and NoSQL databases, often implementing technologies for real-time data streaming and large-scale data processing. Advanced caching mechanisms and content delivery networks may ensure rapid advertisement serving across global networks.

In some embodiments, the source data store 302 and/or the programmatic advertising platform 303 may provide a log interface. Embodiments of log interfaces comprise sophisticated data visualization frameworks built on modern web technologies and real-time data processing systems. Log interfaces utilize JavaScript visualization libraries or specialized dashboard frameworks for creating interactive charts, graphs, and data displays. In some embodiments, log interfaces utilize real-time data streaming technologies and caching layers to ensure responsive performance when querying large conversation datasets. The log interface may utilize advanced search and filtering capabilities such as query optimization algorithms that enable rapid retrieval of specific conversation segments or patterns.

The end user device 304 may be any device according to which an end user can receive advertising materials and/or access a user interface such as a content presentation interface 308 and/or a conversational interface 306. The content presentation interface 308 may be configured to maintain and present The conversational interface 306 may be configured to utilize one or more natural language processing architectures built on transformer-based language models and multi-modal processing systems. The conversational interface 306 may utilize automatic speech recognition (ASR) systems for voice input processing, text-to-speech (TTS) engines for audio output generation, and computer vision models for visual input interpretation. In some embodiments, the conversational interface 306 is configured to utilize real-time communication protocols, often implemented through WebRTC for browser-based interfaces or specialized APIs for mobile and embedded applications. The conversational interface 306 may comprise intent recognition models, dialogue management systems, and response generation engines, all coordinated through orchestration layers that manage conversation state and context. Advanced caching mechanisms and edge computing deployments may ensure low-latency responses across global user bases.

### IV. Example System Operations

Various embodiments of the present disclosure make important technical contributions to computer functionality. In particular, systems and methods are disclosed herein that implement machine learning and responsive optimization techniques for providing AI-based generation of responsive content. These and other benefits may be achieved through specifically trained machine learning models, including through the use of a single machine learning model, or a pipeline of machine learning models that operate together, to provide the data output results as discussed herein.

Various embodiments of the present disclosure may leverage knowledge of a brand’s products, services, messaging, and/or the like to enable generative responsive content to respond in real-time to user questions or submissions. For example, in some embodiments, the predictive computing entity 102 (e.g., predictive computing system) or other predictive machine learning model (e.g., AI) that is configured to generate one or more generative response advertisements may be trained or otherwise fine-tuned based on brand data for one or more particular brands with which the generative response content is associated. When a user interacts with the generative response content, the predictive computing entity 102 or other predictive machine learning model (e.g., AI) processes the user question or submission and may provide relevant, real-time responses within the space of the generative response content itself, without the need for a user to click away.

Various embodiments of the present disclosure are LLM-agnostic, such that any of a variety of large language foundation models may be trained as described herein to provide a seamless, informative, and interactive experience that generates content in response to end-user prompts and which is tailored to provide content in accordance with the GRC data (e.g., for providing answers to questions regarding a particular product or service being offered). For example, some embodiments of the present disclosure leverage applied AI engineering to power such generative response content. Such applied AI engineering may involve creating a tailored layer of customization that integrates prompt engineering, vector databases, and/or deployment strategies. Such a customized engineering layer may enable a generative response content to be highly specific to a brand, product, or use case it serves or is otherwise associated with to deliver real-time, contextually relevant responses directly within the space of the generative response content. For example, rather than relying solely on the capabilities of foundational model, various embodiments of the present disclosure improve such foundational models by integrating brand-specific knowledge and advanced optimization techniques. Example embodiments of the present disclosure may provide interactive generative response content that is aligned with a brand’s messaging, providing value beyond what general purpose, foundational models can offer.

The generative response content may be provided via any user interface content component that defines a dedicated space for users to interact and ask questions or requests. In some embodiments, any standard banner content may be used as the base for a generative response content of the present disclosure. For example, standard banner advertisement specifications may be accessed in preparation of a generative response content of the present disclosure (e.g., best practices for design and optimal ad sizes may be provided). FIG. 3 describes an example embodiment of how the GRC is provided to an end user via an end user device, for example.

To provide accurate and relevant responses, the predictive computing entity 102 or other predictive machine learning model that powers generative response content of the present disclosure may be trained using brand or product training data. Such brand or product training data may include any of a variety of brand or product information about the brand or product being advertised, including but not limited to product descriptions and features, FAQs, current promotions or special offers, relevant customer service details, etc. In some embodiments, the brand or product training data may also include information identifying to where a user should be directed if the user asks a question that does not have the answer. The more comprehensive the brand or product information provided in the training set, the better the AI can engage users with helpful, relevant answers.

Such brand or product training data may be stored in a variety of ways. In a non-limiting embodiment, such brand or product training data may be stored in a vector database in a secure, cloud-based environment, such as AWS. For certain industries or regions with strict data sovereignty requirements (e.g., finance or healthcare), vector databases may be deployed on-premises or in a hybrid configuration. In some embodiments, the predictive computing entity 102 is configured to generate various types of metadata through annotation processes that enhance and contextualize source data to improve conversational AI performance and targeting capabilities. An annotation component of the predictive computing entity 102 may create semantic metadata to be stored with provided brand or product training data, that identifies key concepts, entities, and relationships within the source content, thereby enabling more sophisticated understanding and retrieval operations. In some embodiments, the predictive computing entity 102 generates intent classification metadata categorize content based on the types of user queries it can address, such as product information requests, pricing inquiries, technical support questions, or general brand information. The predictive computing entity 102 may generate and apply emotional tone and sentiment metadata to content segments, indicating whether information should be presented in formal, casual, enthusiastic, or empathetic tones. In some embodiments, the predictive computing entity 102 generates priority and importance metadata to rank content elements based on business objectives, promotional priorities, or strategic messaging requirements.

The predictive computing entity 102 may generate contextual relevance metadata to be stored with provided brand or product training data, indicating the circumstances under which specific content should be presented, such as seasonal promotions, geographic restrictions, user demographic preferences, or device-specific information. In some embodiments, the predictive computing entity 102 generates relationship mapping metadata to establish connections between different content elements, creating semantic networks that enable the system to provide comprehensive responses that draw from multiple related sources. The predictive computing entity 102 may generate compliance and regulatory metadata to identify content that requires special handling due to legal requirements, industry regulations, or privacy considerations.

In some embodiments, the predictive computing entity 102 generates accuracy and freshness metadata to be stored with provided brand or product training data, to track content validation status, source credibility, and last update timestamps, enabling the system to prioritize current and verified information while flagging potentially outdated content for review or replacement. The predictive computing entity 102 may generate user experience metadata indicating optimal presentation formats, such as whether content is best delivered as text, requires visual elements, or should include interactive components. In some embodiments, the predictive computing entity 102 generates performance tracking metadata may capture historical usage patterns, user engagement metrics, and conversion outcomes associated with specific content elements, enabling continuous optimization of content selection and presentation strategies based on real-world effectiveness data.

In some embodiments, responsive to detecting a new source data source (e.g., a new webpage, new curated dataset, etc.), or responsive to receiving a notification that replacement data is available, the predictive computing entity 102 generates updated metadata and/or training data used as context during training of a model, according to the above. In some embodiments, upon detection of new or replacement data, the predictive computing entity 102 triggers retraining of one or more models such as the predictive machine learning model. For example, the predictive computing entity 102 may be configured to trigger retraining of the model based on the updated metadata and or the new training data responsive to detecting/identifying a threshold amount of replacement or new data.

Various embodiments anonymize user interactions with generative response content, ensuring that users are not identified. Additionally or alternatively, in some embodiments, no data is shared externally or used to train the core AI model. Additionally or alternatively still, additional security measures, such as encryption APIs and safeguard user interactions, may be employed in various embodiments of the present disclosure. For example, Personal Identifiable Information (PII) may be protected through de-identification practices in some embodiments, thereby maintaining privacy and compliance with various industry regulations.

Various embodiments of the present disclosure provide for technical improvements to the functioning of electronic content delivery mechanisms that enable integration of GRC into advertisement content distributed according to advertising platforms and formats. In some embodiments, generative response content of the present disclosure easily integrate into existing advertisement platforms and formats such that complex setup may not be required. For example, various embodiments of the present disclosure are compatible with commonly used advertisement management tools, allowing for quick adoption. Some embodiments of the present disclosure integrate a portion of code into a standard banner advertisement such that users (e.g., advertisers and publishers) can leverage currently available advertisement serving platforms with the generative response advertisements of the present disclosure.

In some embodiments, a conversational component of a generative response advertisement of the present disclosure is generated or otherwise initiated when a user starts interacting with the generative response advertisement banner. In some embodiments, such as those where a user may use a user device to interact with (e.g., scan, capture, etc.) a link element configured to enable user interaction with the generative response advertisement, the conversational component of the generative response advertisement may be launched, initiated, or executed at the user device responsive to user interaction with the link element.

Various embodiments of the present disclosure provide such AI-based generation of responsive advertisements with no latency issues compared to existing advertisement platforms and formats. For example, various embodiments are configured to address token consumption and generative response time such that the user does not perceive issues with generative response content in accordance with the present disclosure loading slower than usual or existing advertisement platforms and formats.

In some embodiments, the predictive computing entity 102 (e.g., predictive computing system) or other predictive machine learning model of the present disclosure may be configured to generate reporting data and/or one or more corresponding reports. For example, in some embodiments, the predictive computing entity 102 may be configured to track and provide one or more campaign performance reports, including key metrics like impressions and clicks, by tracking interactions with the generative response content via the conversational interface(s) of the present disclosure. Additionally or alternatively, the predictive computing entity 102 (e.g., predictive computing system) or other predictive machine learning model of the present disclosure may provide anonymized logs of the questions users asked about the advertised product or service. For example, generative response content of the present disclosure may be configured to not collect cookies or any PII to comply with various privacy and security regulations, such as the General Data Protection Regulation (GDPR) and the California Consumer Privacy Act (CCPA). Such insights may provide valuable feedback on user interest and engagement, helping brands refine their messaging and better understand customer needs. In general, the predictive computing entity 102 may be configured to generate one or more reports indicating tracked metrics with respect to user interactions with the generative response content and provide said one or more reports to one or more client devices.

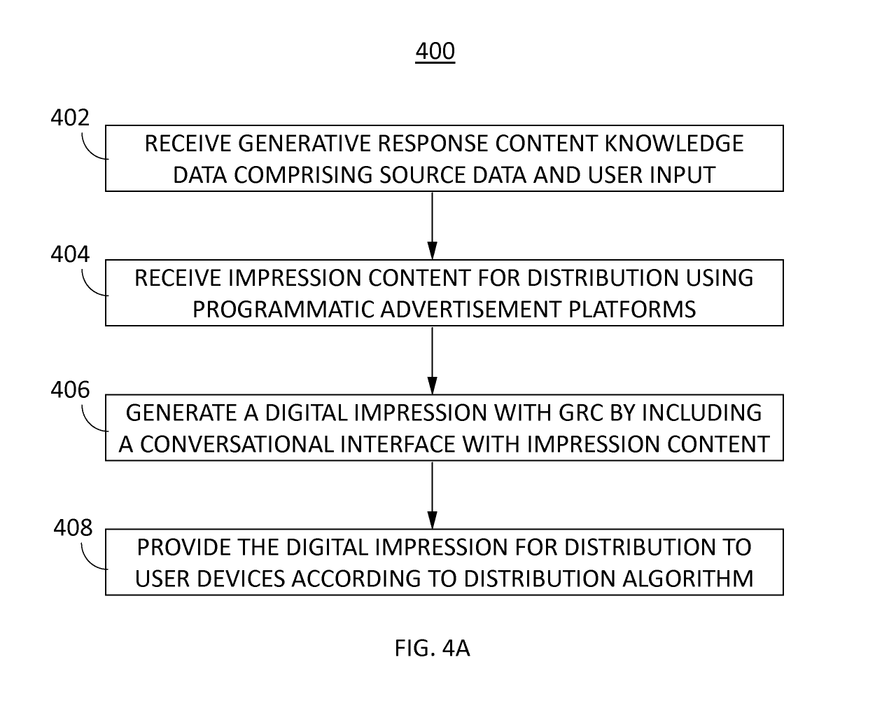

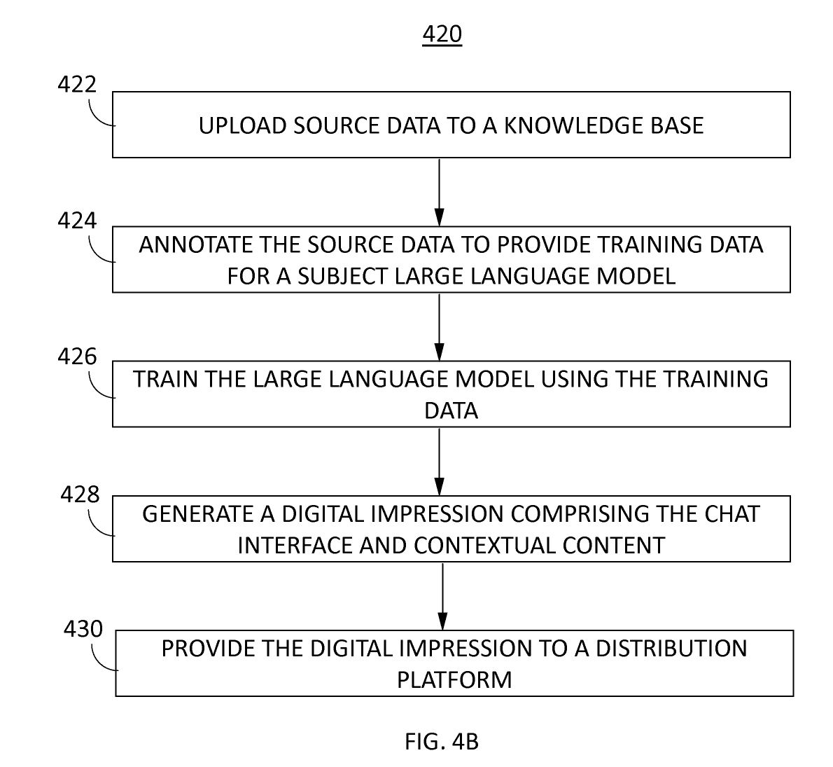

FIG. 4A is a flowchart depicting operational steps of a process 400 for generative response content distribution in accordance with some embodiments of the present invention. As depicted, the process 400 includes receiving (402) generative response content knowledge data comprising source data and user input data, receiving (404) impression content for distribution using programmatic advertisement platforms, generating (406) a digital impression with GRC by including a conversational interface with the impression content, and providing (408) the digital impression for distribution to user devices according to a distribution algorithm.

At step 402, a subject application receives generative response content knowledge data comprising source data and user input data. Receiving (402) generative response content knowledge data comprising source data and user input data may include receiving, from a programmatic advertising platform and/or a source data store, GRC knowledge data comprising source data and user input defining enrichment data for the source data. The GRC knowledge data may be provided by sophisticated data management architectures built on graph databases and vector storage systems optimized for semantic search and retrieval. Such systems may be configured to utilize natural language processing (NLP) pipelines that convert raw source content into structured, machine-readable formats through entity extraction, relationship mapping, and semantic embedding generation. Advanced indexing algorithms may enable rapid retrieval of relevant GRC knowledge data during real-time conversations. The data storage infrastructure typically employs distributed computing systems with redundancy and version control capabilities to ensure data integrity and availability.

At step 404, the subject application receives impression content for distribution using programmatic advertising platforms. Receiving (404) impression content for distribution using programmatic advertisement platforms may comprise receiving impression content intended to be distributed to one or more end users via one or more programmatic advertising platforms. The impression content may be received from content management and rendering systems built on responsive web design frameworks and dynamic content assembly platforms. Such content management and rendering systems may be configured to utilize CSS preprocessing technologies, JavaScript frameworks, and HTML5 standards to create adaptive layouts that function across diverse device types and screen resolutions. In some embodiments, the impression content employs content delivery networks (CDNs) with edge caching capabilities to ensure rapid loading of visual assets, while image optimization algorithms automatically compress and format media files for optimal performance. In some embodiments, templating engines are used to generate impression content, allowing for dynamic assembly of impression content based on targeting parameters, user device capabilities, and real-time bidding contexts. In some embodiments, the digital impression with GRC comprises an Urchin Tracking Module (UTM) parameter.

At step 406, the subject application generates a digital impression with GRC by including a conversational interface with the impression content. Generating (406) a digital impression with GRC by including a conversational interface with the impression content may include accessing the LLM using one of: an Application Program Interface (API) or a Model Context Protocol (MCP). In some embodiments, the digital impression with GRC is one of: a banner advertisement for a webpage; an advertisement for display via a physical advertising device; an audio advertisement for presentation to users using an audio output device; a television commercial for display using a television configured for interactivity with an end user; advertising content accessible using a link provided to an end user. In some embodiments, the digital impression with GRC is advertising content accessible using a QR-code displayed to an end user.

The subject large language models may comprise transformer neural networks with attention mechanisms, potentially comprising billions of parameters distributed across multiple layers of self-attention and feed-forward networks. In some embodiments, the LLMs are trained using unsupervised learning techniques on massive datasets containing diverse text sources, employing distributed computing systems with specialized hardware such as GPUs or TPUs for efficient parallel processing. The training process may utilize gradient descent optimization algorithms, in some embodiments combined with techniques like gradient clipping and learning rate scheduling to manage the complexity of large-scale optimization. In some embodiments, the LLMs provide an optimized serving infrastructure that can handle high-throughput requests while managing memory and computational requirements. Advanced implementations of the LLMs may include techniques like model quantization, pruning, or distillation to reduce computational overhead while maintaining performance.

Embodiments of MCP comprise sophisticated protocol design built on structured data exchange formats and real-time communication architectures. MCP systems utilize standardized message formats, often implemented through protocol buffers or JSON schemas, that define the structure and semantics of context information exchange. MCP infrastructures may comprise message queuing systems and event-driven architectures that enable asynchronous communication between models and external systems, with reliability mechanisms such as message acknowledgment, retry logic, and error handling. In some embodiments, MCP implementations incorporate context compression algorithms to optimize data transfer efficiency, versioning systems to manage protocol evolution, and security mechanisms including encryption and authentication to protect sensitive context information during transmission.

At step 408, the subject application provides the digital impression for distribution to user devices according to a distribution algorithm. Providing (408) the digital impression for distribution to user devices according to a distribution algorithm may include utilizing machine learning systems built on ensemble methods, deep learning architectures, and/or optimization algorithms designed for high-frequency decision-making. In some embodiments, the distribution algorithm may utilize reinforcement learning models that continuously adapt based on performance feedback, employing techniques such as multi-armed bandit algorithms for exploration-exploitation trade-offs in advertisement placement. The distribution algorithm may comprise a real-time data processing pipelines implemented using stream processing frameworks with predictive models deployed on distributed computing clusters. Advanced caching mechanisms and edge computing deployments may enable millisecond-level decision-making required for real-time bidding environments. The distribution algorithm may be configured to incorporate various optimization objectives including click-through rates, conversion probabilities, and return on advertising spend, using techniques such as linear programming and genetic algorithms for multi-objective optimization.

The large language models may comprise transformer neural networks with attention mechanisms, typically comprising billions of parameters distributed across multiple layers of self-attention and feed-forward networks. Large language models are trained using unsupervised learning techniques on massive datasets containing diverse text sources, employing distributed computing systems with specialized hardware such as GPUs or TPUs for efficient parallel processing. The training process utilizes gradient descent optimization algorithms, often with techniques like gradient clipping and learning rate scheduling to manage the complexity of large-scale optimization. Model inference is implemented through optimized serving infrastructure that can handle high-throughput requests while managing memory and computational requirements. Advanced implementations may include techniques like model quantization, pruning, or distillation to reduce computational overhead while maintaining performance.

In some embodiments, the impression content comprises metadata defining target end users and the distribution algorithm uses the metadata for distributing the digital impression with GRC to the end users. In such embodiments, the GRC knowledge data may comprise a plurality of end user profiles, wherein each end user profile comprises source data, enrichment data, and one or more end user definitions. In such embodiments, generating the digital impression with GRC comprises using the metadata of the impression content and GRC knowledge data within an end user profile matching the target end users of the metadata of the impression content to generate the conversational interface.

In some embodiments, the process 400 further includes receiving, using the one or more processors, interaction data comprising one or more conversation logs for conversations with end users using the conversation interface within the digital impression with GRC. The process 400 may further include generating a log interface comprising the interaction data.

Embodiments of interaction data collection and management may comprise sophisticated data pipeline architectures built on real-time streaming platforms and distributed storage systems. Data pipeline architectures utilize event-driven architectures implemented through message queuing systems to capture user interactions in real-time. The data storage infrastructure may utilize both structured databases for metadata and time-series databases for sequential interaction data, and may utilize technologies for efficient temporal data management. Advanced data processing pipelines implement ETL (Extract, Transform, Load) processes using frameworks with machine learning models for data quality assessment, anomaly detection, and automated data enrichment. Privacy-preserving technologies such as differential privacy and data anonymization algorithms are integrated to ensure compliance with data protection regulations.

Embodiments of conversation logs may comprise sophisticated logging architectures built on distributed storage systems optimized for high-volume, sequential data ingestion. Logging architectures utilize structured logging formats to ensure consistent data schemas and efficient querying capabilities. The logging architectures may employ time-series databases or document stores that are optimized for temporal data retrieval and full-text search across conversation content. In some embodiments, the logging architectures utilize indexing strategies that enable rapid retrieval of specific conversations or conversation segments based on various criteria including keywords, user identifiers, timestamps, or conversation outcomes. Data retention policies and archival systems manage long-term storage while ensuring compliance with privacy regulations and data governance requirements.

In some embodiments, generating the log interface comprises using an artificial intelligence-based summary model to generate a summary of the interaction data. The summary model may comprise advanced natural language processing and machine learning frameworks utilizing transformer-based architectures fine-tuned for summarization tasks. Summary models may comprise encoder-decoder architectures with attention mechanisms that can process variable-length conversation sequences and generate structured summaries. The training process for a summary model may comprise supervised learning on curated datasets of conversation-summary pairs, often augmented with reinforcement learning techniques to optimize for specific summary quality metrics. The summary model architecture includes specialized components for different types of analysis, such as sentiment analysis modules using BERT-based models, topic modeling systems employing Latent Dirichlet Allocation (LDA) or neural topic models, and statistical analysis engines for quantitative metrics calculation. The summary model may utilize an inference infrastructure implemented on scalable computing platforms with GPU acceleration for efficient batch processing of large conversation datasets.

In some embodiments, the process 400 further includes providing one or more test queries to the conversational interface. The process 400 may further include validating responses generated by the conversational interface by comparing the responses with the GRC knowledge data. The process 400 may further include generating a validation metric based at least in part on the validating. The process 400 may further include generating a validation user interface for presentation to an administrator, wherein the validation user interface comprises the validation metric.

Embodiments of test query systems comprise automated testing frameworks built on continuous integration and deployment (CI/CD) pipelines that can execute large-scale testing procedures across multiple conversational AI instances. Automated testing frameworks utilize test orchestration platforms that manage query execution, response collection, and performance measurement through APIs and automated scripts. The automated testing framework may include test data management systems that organize queries by categories, difficulty levels, and expected outcomes, often implemented using version-controlled repositories with metadata tagging systems. In some embodiments, test query systems incorporate machine learning models for automatic test case generation, using techniques such as adversarial example generation and mutation testing to create challenging scenarios that probe system limitations.

Embodiments of validation metrics involves comprehensive measurement systems built on data analytics platforms that collect, process, and analyze multiple performance indicators in real-time. Measurement systems utilize statistical analysis frameworks that calculate metrics such as response accuracy using semantic similarity algorithms, conversation completion rates through session analysis, and user satisfaction scores derived from sentiment analysis and explicit feedback collection. The validation metrics may include time-series databases for tracking metric evolution over time, comparative analysis tools for benchmarking against baseline performance, and alerting systems that notify administrators when metrics fall below acceptable thresholds.

Embodiments of validation user interfaces involves sophisticated web-based dashboard frameworks built on modern frontend technologies and real-time data processing systems. Validation user interfaces utilize responsive web design principles implemented through frameworks like React or Angular, with data visualization components powered by libraries for creating interactive charts and graphs. The backend infrastructure employs APIs and WebSocket connections for real-time data streaming, with caching layers and database optimization to ensure responsive performance when displaying large datasets. Advanced interface features may include drag-and-drop configuration tools for test setup, interactive parameter adjustment controls for model tuning, and collaborative features that enable team-based system optimization.

In some embodiments, the process 400 further includes receiving source data comprising one or more of: a webpage uniform resource locator (URL), a text file, an image file, or a video file. The process 400 may further include receiving user input defining enrichment data for each source data using a graphical user interface. The process 400 may further include storing each source data with the enrichment data received for corresponding source data.

In some embodiments, the process 400 further includes receiving business parameters defining a behavior for the conversational interface. In some embodiments, the conversational interface within the digital parameter may be configured to interact with end users according to the business parameters. Embodiments of business parameters may be provided by sophisticated configuration management systems built on flexible parameter storage and retrieval architectures. Configuration management systems utilize hierarchical configuration databases that organize parameters by categories such as personality traits, response formatting, content preferences, and interaction styles. In some embodiments, the configuration management systems employ template engines and dynamic content generation systems that apply business parameters in real-time during conversation processing, using rule-based systems and machine learning models to ensure consistent parameter application across all interactions. Advanced parameter management systems include version control capabilities for tracking parameter changes over time, A/B testing frameworks for optimizing parameter configurations, and inheritance mechanisms that allow parameter hierarchies from global brand settings to specific campaign customizations.

In some embodiments, the process 400 further includes receiving alternative impression content that does not include a conversational interface. The process 400 may further include monitoring the LLM for status changes. Upon detecting an error of the LLM, the process 400 may further include providing the alternative impression content for distribution over the network by the one or more programmatic advertising platforms to end user devices according to the distribution algorithm instead of the digital impression.

FIG. 4B is a flowchart depicting operational steps of a process 420 for generative response content generation in accordance with some embodiments of the present invention. As depicted, the process 400 includes uploading (422) source data to a knowledge base, annotating (424) the source data to provide training data for a large language model (LLM), training (426) the LLM using the training data, generating (428) a digital impression comprising a conversational interface and contextual content, and providing (430) the digital impression to a distribution platform.

At step 422, the predictive computing entity 102 uploads source data to a knowledge base. Uploading (422) source data to a knowledge base, may involve a multi-stage process that transforms raw content into structured, searchable information suitable for powering conversational AI responses. The predictive computing entity 102 may initiate the process when administrators or content managers access the content management interface to submit various types of source materials.

In some embodiments, the predictive computing entity 102 accepts diverse source data formats including webpage URLs, text documents, PDF files, images, videos, spreadsheets, and structured data files. When the predictive computing entity 102 receives URLs, it may execute automated web scraping algorithms that extract content from specified web pages, parsing HTML structures to identify relevant text, metadata, and embedded media while respecting website access policies and rate limitations.

In some embodiments, predictive computing entity 102 implements file upload mechanisms that support both individual file submissions and batch processing capabilities for large content collections. The predictive computing entity 102 may provide drag-and-drop interfaces that simplify the upload process while delivering real-time feedback about file processing status and any encountered errors or validation issues.

In some embodiments, the predictive computing entity 102 executes content processing pipelines that automatically analyze uploaded materials to extract machine-readable information. The predictive computing entity 102 may apply natural language processing to text-based content to identify key concepts, entities, and semantic structures. In some embodiments, the predictive computing entity 102 processes image and video files using computer vision algorithms to generate descriptive metadata and extract any textual information present in visual content.

At step 424, the predictive computing entity 102 annotates the source data to provide metadata stored with the source data as a part of training data for a large language model. Annotating (424) the source data to provide training data for a large language model (LLM) may comprise annotating source data to provide training data for a large language model through systematic enrichment processes that may add structured metadata and contextual information to raw content. The predictive computing entity 102 may begin annotation by analyzing uploaded source data through natural language processing pipelines that may identify key entities, concepts, and semantic relationships within the content.

In some embodiments, the predictive computing entity 102 applies intent classification algorithms that may categorize content segments based on the types of user queries they address, such as product information, pricing details, technical specifications, or customer service topics. The predictive computing entity 102 may assign intent labels to each content piece, enabling the large language model to understand the purpose and appropriate usage context for specific information.

In some embodiments, the predictive computing entity 102 executes sentiment analysis procedures that may determine the emotional tone and communication style appropriate for different content segments. The predictive computing entity 102 may tag content with sentiment metadata indicating whether responses should be formal, casual, enthusiastic, or empathetic, ensuring the large language model may maintain consistent brand voice across all interactions.

In some embodiments, the predictive computing entity 102 implements entity recognition processes that may identify and label specific products, services, locations, dates, prices, and other factual elements within the source content. The predictive computing entity 102 may create structured annotations that may enable the large language model to accurately reference specific details when generating responses to user queries.

In some embodiments, the predictive computing entity 102 applies topic modeling algorithms that may group related content into thematic categories and establish hierarchical relationships between different subject areas. The predictive computing entity 102 may create topic annotations that may help the large language model understand content organization and provide comprehensive responses that draw from multiple related sources.

In some embodiments, the predictive computing entity 102 executes relationship mapping procedures that may identify connections between different content elements, creating semantic networks that may link related products, services, or concepts. The predictive computing entity 102 may annotate these relationships to enable the large language model to provide cross-referenced information and suggest relevant alternatives or complementary offerings.

In some embodiments, the predictive computing entity 102 implements priority ranking algorithms that may assign importance scores to different content segments based on business objectives, promotional strategies, or strategic messaging requirements. The predictive computing entity 102 may create priority annotations that may guide the large language model in emphasizing key information and aligning responses with business goals.

In some embodiments, the predictive computing entity 102 applies contextual relevance tagging that may indicate when specific content should be presented based on user demographics, geographic location, seasonal factors, or device characteristics. The predictive computing entity 102 may create contextual annotations that may enable the large language model to personalize responses based on real-time user context and environmental factors.

In some embodiments, the predictive computing entity 102 executes quality assessment procedures that may validate content accuracy, freshness, and compliance with brand guidelines. The predictive computing entity 102 may assign quality scores and compliance flags that may inform the large language model about content reliability and appropriate usage constraints.

At step 426, the predictive computing entity 102 trains the LLM using the training data. Training (426) the LLM using the training data may include utilizing comprehensive machine learning processes that may optimize the model's performance for generating contextually relevant responses. The predictive computing entity 102 may begin by preprocessing the annotated training data into structured datasets that may contain input-output pairs, contextual examples, and quality indicators suitable for neural network training.

In some embodiments, the predictive computing entity 102 implements data preparation pipelines that may convert annotated source content into tokenized sequences compatible with the LLM's input requirements. The predictive computing entity 102 may create training examples by pairing user query patterns with corresponding responses derived from the knowledge base, which may ensure the model learns to associate specific inputs with appropriate, brand-aligned outputs.

In some embodiments, the predictive computing entity 102 executes fine-tuning procedures that may adapt pre-trained language models to the specific domain and requirements of the generative response content application. The predictive computing entity 102 may adjust model parameters through gradient descent optimization algorithms that may minimize prediction errors between generated responses and target outputs from the training data.

In some embodiments, the predictive computing entity 102 implements supervised learning workflows that may feed training examples through the neural network architecture, which may calculate loss functions that measure the difference between predicted and actual responses. The predictive computing entity 102 may backpropagate error signals through the network layers, which may update weights and biases to improve response accuracy and relevance.

In some embodiments, the predictive computing entity 102 applies regularization techniques that may prevent overfitting by introducing constraints on model complexity and parameter values. The predictive computing entity 102 may implement dropout mechanisms, weight decay, and early stopping procedures that may ensure the trained model generalizes effectively to new, unseen user queries.

In some embodiments, the predictive computing entity 102 executes validation procedures that may evaluate model performance using held-out datasets not included in the training process. The predictive computing entity 102 may measure metrics such as response accuracy, semantic similarity, and brand consistency to assess training effectiveness and may identify areas requiring additional optimization.

In some embodiments, the predictive computing entity 102 implements iterative training cycles that may continuously refine model performance through multiple epochs of data exposure. The predictive computing entity 102 may adjust learning rates, batch sizes, and other hyperparameters based on validation results to optimize convergence and may prevent training instabilities.

In some embodiments, the predictive computing entity 102 applies transfer learning techniques that may leverage knowledge from pre-trained foundation models while adapting to the specific requirements of the brand's knowledge base. The predictive computing entity 102 may preserve general language understanding capabilities while specializing the model for domain-specific response generation.

In some embodiments, the predictive computing entity 102 executes distributed training processes that may utilize multiple processing units to accelerate model optimization and may handle large-scale datasets efficiently. The predictive computing entity 102 may coordinate gradient updates across parallel computing resources to maintain training consistency and may reduce overall training time.

In some embodiments, the predictive computing entity 102 implements checkpoint mechanisms that may save model states at regular intervals, which may enable recovery from training interruptions and may facilitate model versioning for deployment and rollback purposes. The predictive computing entity 102 may maintain training logs that may track performance metrics, loss values, and hyperparameter configurations throughout the training process.

At step 428, the predictive computing entity 102 generates a digital impression comprising a conversational interface and contextual content. Generating (428) a digital impression comprising a conversational interface and contextual content may include utilizing integrated content assembly processes that may combine interactive AI components with traditional advertising elements. The predictive computing entity 102 may begin by retrieving impression content specifications that may define visual layouts, brand elements, messaging requirements, and target audience parameters for the digital advertisement.

In some embodiments, the predictive computing entity 102 implements template rendering engines that may dynamically assemble visual components including brand imagery, color schemes, typography, and marketing copy into cohesive advertisement layouts. The predictive computing entity 102 may apply responsive design algorithms that may optimize content presentation across different device types, screen sizes, and platform requirements to ensure consistent user experiences.

In some embodiments, the predictive computing entity 102 integrates conversational interface components that may provide interactive text input fields, chat windows, or voice interaction capabilities within the advertisement space. The predictive computing entity 102 may configure these interface elements to maintain visual consistency with the surrounding impression content while providing clear affordances for user interaction and engagement.

In some embodiments, the predictive computing entity 102 connects the conversational interface to the trained large language model through API integrations or Model Context Protocol implementations that may enable real-time response generation. The predictive computing entity 102 may establish communication pathways that may allow user inputs to be processed by the AI system and responses to be displayed within the advertisement interface without requiring page redirects or external navigation.

In some embodiments, the predictive computing entity 102 applies business parameters and brand guidelines to configure the conversational interface behavior, which may include response tone, interaction style, content boundaries, and escalation procedures. The predictive computing entity 102 may implement safeguards that may ensure all generated responses remain aligned with advertiser messaging strategies and compliance requirements.

In some embodiments, the predictive computing entity 102 incorporates contextual targeting logic that may personalize both the visual content and conversational capabilities based on user demographics, behavioral data, geographic location, and real-time context signals. The predictive computing entity 102 may select appropriate knowledge base segments and response strategies that may align with the identified user characteristics and preferences.

In some embodiments, the predictive computing entity 102 implements tracking and analytics components that may monitor user interactions, conversation patterns, and engagement metrics within the digital impression. The predictive computing entity 102 may embed UTM parameters, conversion tracking pixels, and performance measurement tools that may enable comprehensive campaign analysis and optimization.

In some embodiments, the predictive computing entity 102 applies content delivery optimization techniques that may ensure rapid loading and smooth performance of both static impression elements and dynamic conversational components. The predictive computing entity 102 may utilize caching mechanisms, content compression, and edge distribution networks that may minimize latency and provide responsive user experiences across diverse network conditions.

In some embodiments, the predictive computing entity 102 generates fallback content alternatives that may be displayed when conversational AI components are unavailable or incompatible with user environments. The predictive computing entity 102 may implement detection mechanisms that may identify technical limitations and may automatically substitute appropriate alternative content to maintain advertisement delivery continuity.

In some embodiments, the predictive computing entity 102 packages the completed digital impression with all necessary code, assets, and configuration parameters for distribution through programmatic advertising platforms, which may ensure seamless integration with existing advertisement serving infrastructure and campaign management systems.

At step 430, the predictive computing entity 102 provides the digital impression to a distribution platform. Providing (430) the digital impression to a distribution platform may include providing the digital impression to a distribution platform through automated delivery processes that may integrate with programmatic advertising infrastructure and campaign management systems. The predictive computing entity 102 may begin by formatting the digital impression according to industry-standard advertisement specifications that may include Interactive Advertising Bureau (IAB) guidelines, platform-specific requirements, and technical compatibility parameters.

In some embodiments, the predictive computing entity 102 packages the digital impression components including HTML markup, CSS styling, JavaScript functionality, media assets, and conversational interface code into deliverable advertisement units. The predictive computing entity 102 may compress and optimize these components to meet file size limitations and performance requirements established by distribution platforms and advertising networks.

In some embodiments, the predictive computing entity 102 establishes secure communication channels with programmatic advertising platforms through API connections, authentication protocols, and data exchange interfaces. The predictive computing entity 102 may transmit advertisement metadata including targeting parameters, bid strategies, budget allocations, and campaign objectives that may guide the distribution platform's placement decisions.

In some embodiments, the predictive computing entity 102 uploads creative assets and executable code to content delivery networks or advertisement serving platforms that may host the digital impression components for global distribution. The predictive computing entity 102 may configure caching policies, geographic distribution settings, and performance optimization parameters that may ensure rapid content delivery across diverse network conditions.

In some embodiments, the predictive computing entity 102 implements quality assurance procedures that may validate the digital impression's functionality, compatibility, and performance characteristics before release to distribution platforms. The predictive computing entity 102 may execute automated testing protocols that may verify conversational interface responsiveness, visual rendering accuracy, and cross-platform compatibility.

In some embodiments, the predictive computing entity 102 establishes fallback mechanisms that may provide alternative content when primary digital impression components encounter technical issues or compatibility problems. The predictive computing entity 102 may configure automatic failover procedures that may substitute static advertisement content when conversational AI features are unavailable or malfunctioning.

In some embodiments, the predictive computing entity 102 coordinates with demand-side platforms, supply-side platforms, and advertisement exchanges to ensure proper integration with real-time bidding systems and audience targeting mechanisms. The predictive computing entity 102 may provide bid optimization algorithms and audience matching criteria that may guide automated placement decisions across available inventory.

In some embodiments, the predictive computing entity 102 implements version control and update mechanisms that may enable real-time modifications to distributed digital impressions without disrupting active campaigns. The predictive computing entity 102 may maintain deployment pipelines that may push updates to conversational AI models, knowledge base content, or visual elements across all active distribution channels.

In some embodiments, the predictive computing entity 102 monitors distribution platform performance and may adjust delivery parameters based on real-time feedback regarding advertisement serving rates, user engagement levels, and technical performance metrics. The predictive computing entity 102 may optimize distribution strategies to maximize reach, engagement, and conversion outcomes while maintaining cost efficiency and campaign objectives.

### V. Example Use Cases

In programmatic advertising environments, GRC may be deployed as digital impressions configured to combine visual advertising elements with embedded conversational interfaces. These advertisements can be distributed using existing programmatic advertising platforms using distribution algorithms, thereby enabling advertisers to reach targeted audiences while providing enhanced engagement opportunities. In some embodiments, a GRC conversational interface may be provided as a chat window, voice interaction capability, or other input mechanism via which an end user can submit queries directly within the advertisement space, such as in a container dedicated to advertisements on a webpage.

GRC advertisements may be implemented across various media formats, including banner advertisements on websites, interactive television commercials accessible through connected TV platforms, audio advertisements with voice interaction capabilities, and mobile advertising formats optimized for touch and voice input. In some embodiments, GRC may comprise alternative impression content when conversational capabilities are unavailable due to technical limitations, system failures, and/or the like, thereby ensuring consistent content delivery across diverse environments and conditions.

With respect to the advertising space, GRC systems may be configured to include real-time response generation, UTM parameter tracking for attribution analysis, interaction caps to manage campaign costs, comprehensive analytics systems that measure both traditional advertising metrics and conversational engagement indicators, and the like. The GRC may be configured to be distributed using programmatic advertising systems configured to transmit traditional advertising content, such that the GRC may be provided using the same mechanisms and via the same outlets as traditional static advertising content.

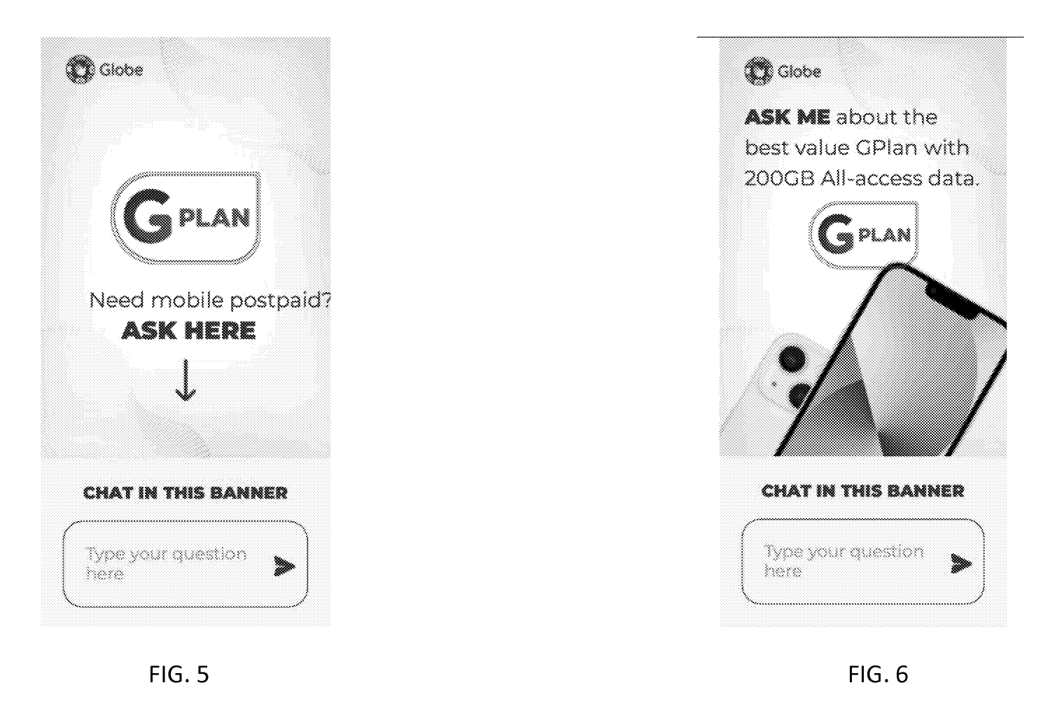

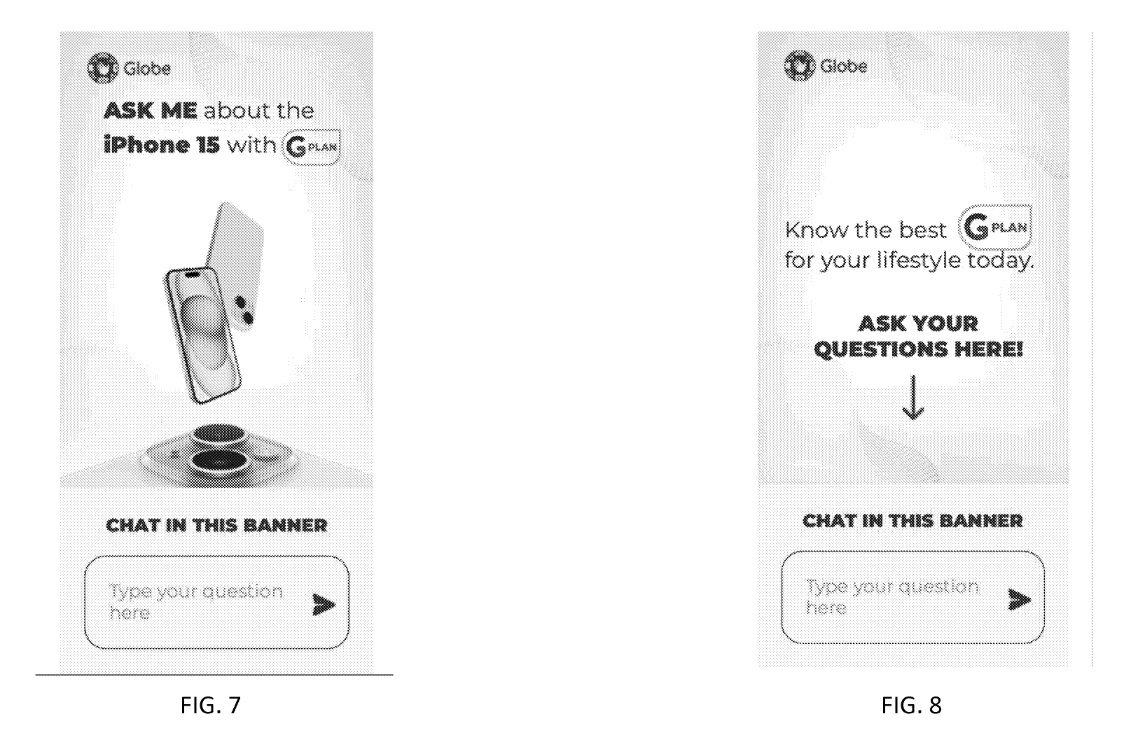

FIGS. 5-15 illustrate example generative response content spaces in accordance with various embodiments of the present disclosure. FIG. 5 depicts a first generative response content space comprising banner content corresponding to mobile postpaid and a chat interface comprising preview text prompting users to provide chat input via the chat interface. FIG. 6 depicts a second generative response content space comprising banner content prompting a user to inquire about a cellphone data plan and a chat interface comprising preview text prompting users to provide their input via the chat interface. FIG. 7 depicts a third generative response content space comprising banner content prompting a user to inquire about a cellphone model and a chat interface comprising preview text prompting users to provide their input via the chat interface.

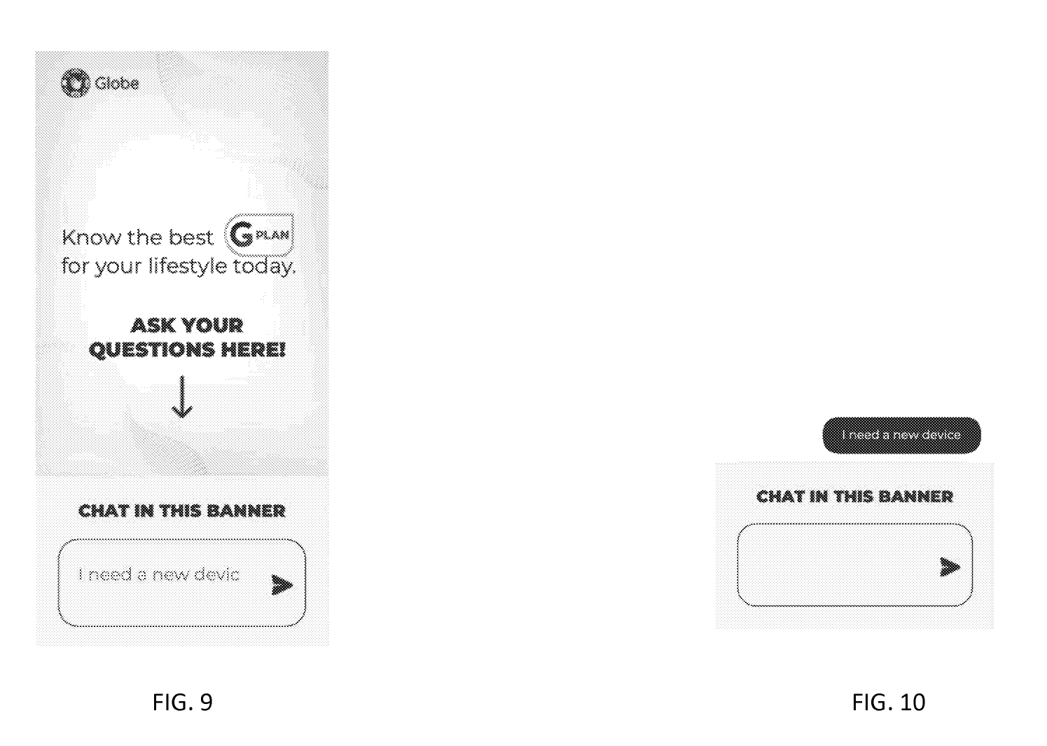

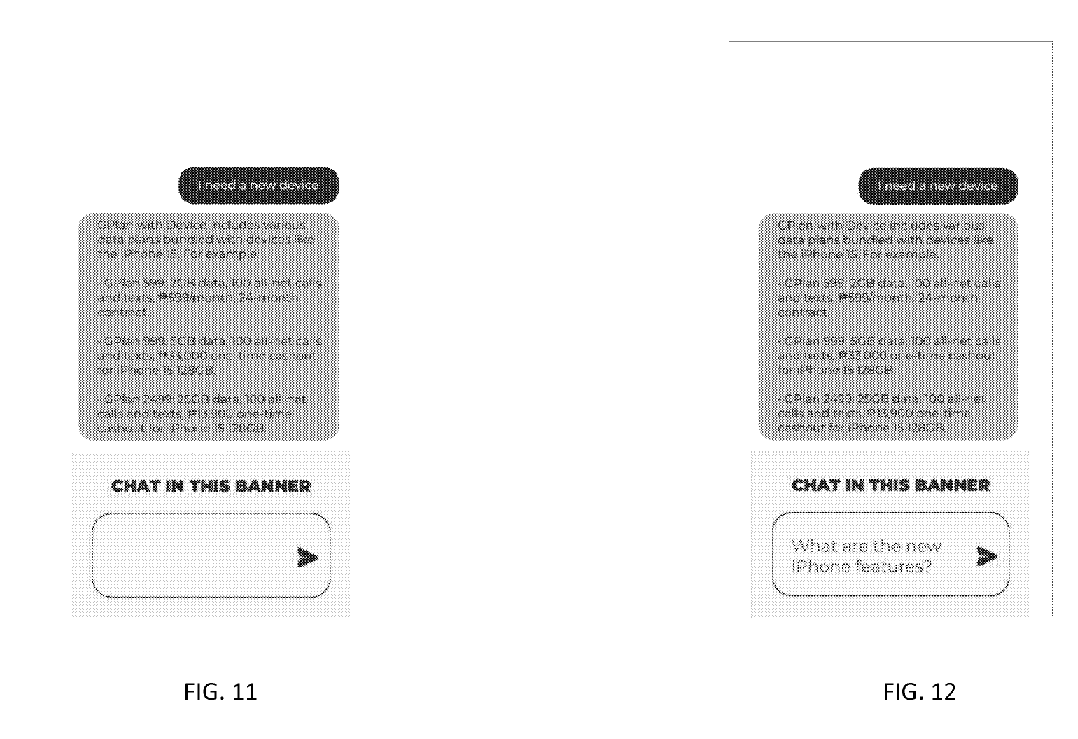

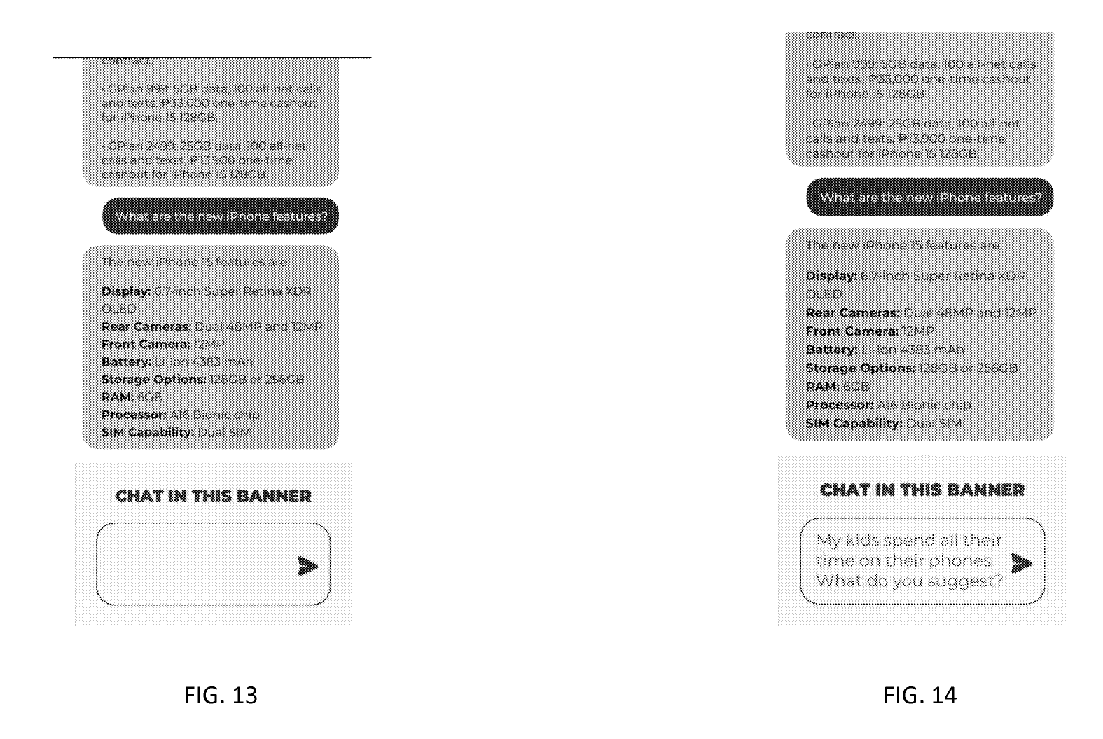

FIG. 8 depicts a fourth generative response content space comprising banner content prompting users to inquire about a best plan for their lifestyle and a chat window comprising preview text prompting users to provide their input via the chat interface. FIG. 9 depicts the fourth generative response content space subsequent to receipt of user text input indicating “I need a new device.” FIG. 10 depicts a fifth generative response content space, generated responsive to receipt of the user text input, the fifth generative response content space comprising an extended chat window. FIG. 11 depicts a continuation of the conversation of the fifth generative response content space comprising an LLM-generated response to the user text input, wherein the LLM-generated response indicates a plurality of plans available for user selection which meet the user’s requirements. FIG. 12 depicts the fifth generative response content space subsequent to receipt of a second user text input requesting information regarding new phone features. FIG. 13 depicts a continuation of the conversation of the fifth generative response content space comprising a second LLM-generated response to the second user text input.

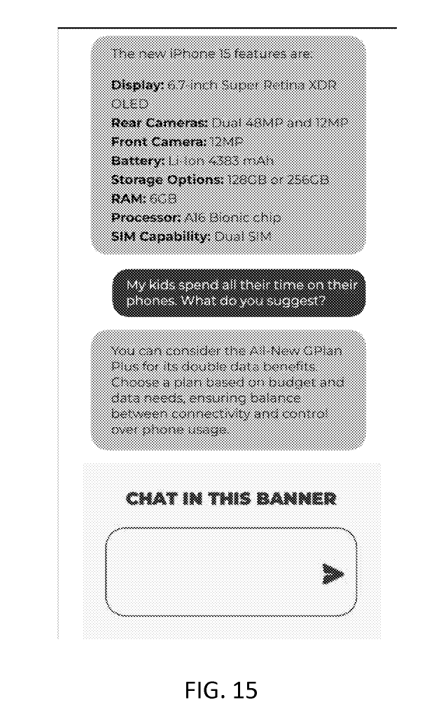

FIG. 14 depicts a continuation of the conversation of the fifth generative response content space comprising a third user text input requesting suggestions regarding children spending all their time on their phones. FIG. 15 depicts a continuation of the conversion of the fifth generative response content space comprising a third LLM-generated response to the third user input indicating an appropriate cellphone plan for addressing the concerns described via the third user input.

It should be appreciated that, though the above examples include references to advertising concepts and features, the techniques as described herein are not limited to advertising platforms and data. Rather, embodiments of the present disclosure enable generation and distribution of GRC in any environment wherein it may be beneficial to leverage static content distribution techniques to provide dynamic generative response content with which an end user can interact.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of any appended claims. Although specific terms are employed herein, they are used in a generic and descriptive sense only and not for purposes of limitation.

1. A system for providing generative response content (GRC) within digital impressions, the system comprising a memory and one or more processors configured to:
receive, using the one or more processors, GRC knowledge data for storage in the memory, wherein the GRC knowledge data comprises source data and user input defining enrichment data for the source data;
receive, using the one or more processors, impression content, wherein the impression content is configured for distribution using one or more programmatic advertising platforms;
generate, using the one or more processors, a digital impression with GRC by including a conversational interface within the impression content, wherein the conversational interface uses a large language model (LLM) trained to generate responses using the GRC knowledge data; and
providing, using the one or more processors, the digital impression with GRC for distribution over a network by the one or more programmatic advertising platforms to end user devices according to a distribution algorithm.

2. The system for providing GRC within digital impressions of claim 1, wherein the one or more processors are further configured to:
receive, using the one or more processors, interaction data comprising one or more conversation logs for conversations with end users using the conversational interface within the digital impression with GRC; and
generate, using the one or more processors, a log interface comprising the interaction data.

3. The system for providing GRC within digital impressions of claim 2, wherein generating the log interface comprises using an artificial intelligence-based summary model to generate a summary of the interaction data.

4. The system for providing GRC within digital impressions of claim 1, wherein the one or more processors are further configured to:
provide one or more test queries to the conversational interface;
validate responses generated by the conversational interface by comparing the responses with the GRC knowledge data;
generate a validation metric based at least in part on the validating; and
generate a validation user interface for presentation to an administrator, wherein the validation user interface comprises the validation metric.

5. The system for providing GRC within digital impressions of claim 1, wherein receiving the GRC knowledge data comprises:
receiving source data comprising one or more of: a webpage uniform resource locator (URL), a text file, an image file, or a video file;
receiving user input defining enrichment data for each source data using a graphical user interface; and
storing each source data with the enrichment data received for corresponding source data.

6. The system for providing GRC within digital impressions of claim 1, wherein generating the digital impression with GRC comprises accessing the LLM using one of: an Application Program Interface (API) or a Model Context Protocol (MCP).

7. The system for providing GRC within digital impressions of claim 1, wherein the one or more processors are further configured to:
receive business parameters defining a behavior for the conversational interface, wherein the conversational interface within the digital impression is configured to interact with end users according to the business parameters.

8. The system for providing GRC within digital impressions of claim 1, wherein the impression content comprises metadata defining target end users and wherein the distribution algorithm uses the metadata for distributing the digital impression with GRC to the target end users;
wherein the GRC knowledge data comprises a plurality of end user profiles, wherein each end user profile comprises source data, enrichment data, and one or more end user definitions; and
wherein generating the digital impression with GRC comprises using the metadata of the impression content and GRC knowledge data within an end user profile matching the target end users of the metadata of the impression content to generate the conversational interface.

9. The system for providing GRC within digital impressions of claim 1, wherein the digital impression with GRC is one of: a banner advertisement for a webpage; an advertisement for display via a physical advertising device; an audio advertisement for presentation to users using an audio output device; a television commercial for display using a television configured for interactivity with an end user; advertising content accessible using a link provided to an end user.

10. The system for providing GRC within digital impressions of claim 1, wherein the digital impression with GRC is advertising content accessible using a QR-code displayed to an end user.

11. The system for providing GRC within digital impressions of claim 1, wherein the one or more processors are further configured to:
receive alternative impression content that does not include a conversational interface;
monitor the LLM for status changes; and
upon detecting an error of the LLM, provide the alternative impression content for distribution over the network by the one or more programmatic advertising platforms to end user devices according to the distribution algorithm instead of the digital impression.

12. The system for providing GRC within digital impressions of claim 2, wherein the digital impression with GRC comprises an Urchin Tracking Module (UTM) parameter.

13. The system for providing GRC within digital impressions of claim 1, wherein receiving the GRC knowledge data comprises replacing the source data with updated source data.
